(19) United States
(12) Patent Application Publication
(10) Pub. No.: US 2005/0197739 A1
(43) Pub. Date: Sep. 8, 2005

(54) Behavior controlling system and behavior controlling method for robot

(76) Inventors: Kuniaki Noda, Tokyo (JP); Shinya Ohtani, Kanagawa (JP); Tsutomu Sawada, Tokyo (JP); Yukiko Yoshiike, Tokyo (JP); Masahiro Fujita, Saitama (JP)

Correspondence Address: William S. Frommer, Esq.;FROMMER LAWRENCE & HAUG LLP, 745 Fifth Avenue, New York, NY, 10151, US

(21) Appl. No.: 11/035,811

(22) Filed: Jan. 14, 2005

(30) Foreign Application Priority Data
Jan. 16, 2004 (JP) 2004-009689

(51) Int. Cl. G06F 19/00

(52) U.S. Cl. 700/245

(57) ABSTRACT

A behavior control system and a behavior control method for a robot apparatus are disclosed. The behavior control system and the behavior control method for a robot apparatus include a function of adaptively switching between a behavior selection standard, taking into account the own state, required of an autonomous robot, and a behavior selection standard, taking into account the state of a counterpart, responsive to a situation. A behavior selection control system in a robot apparatus includes a situation-dependent behavior layer (SBL), capable of selecting a particular behavior from plural behaviors, and outputting the so selected behavior, and an AL calculating unit 120 for calculating the AL (activation level), indicating the priority of execution of the behaviors, for behavior selection. This AL calculating unit 120 includes a self AL calculating unit 122 and a counterpart AL calculating unit 124 for calculating the self AL and the counterpart AL, and an AL integrating unit 125 for summing the self AL and the counterpart AL with weighting by a parameter used for determining whether emphasis is to be placed on the self state or on the counterpart state, to output an ultimate AL. The counterpart is a subject of interaction of the robot apparatus. The self AL and the counterpart AL indicate the priority of execution of the behavior with the self and with the co8unbterpart as a reference, respectively.

### BACKGROUND OF THE INVENTION

1. Field of the Invention

This invention relates to a behavior control system for a robot apparatus, autonomously demonstrating the behavior responsive to the self state and to the surrounding state, and to a behavior controlling system for the robot apparatus.

This application claims priority of Japanese Patent Application No. 2004-009689, filed on Jan. 16, 2004, the entirety of which is incorporated by reference herein.

2. Related Art

A conventional for autonomous behavior selection, so far used in entertainment robot apparatus, has satisfaction of the self state as basic requirement. Hence, when the robot apparatus is autonomously selecting its behavior, the behavior of playing with a ball, lying down, or of requesting electrical charging, occurs one after another in keeping with external stimuli to the robot apparatus or with lapse of time, irrespective of the state of a subject of communication or interaction. This technique of behavior control is sufficient to meet the demand for realizing communication with an entertainment-oriented robot apparatus, from the perspective of, as it were, caressing an animal, with the human directing his/her attention to and taking care of the robot apparatus performing its own wayward behavior (see, for example, the following Patent Publication 1).

On the other hand, a variety of methods for having a robot apparatus perform a behavior which takes into account the request of the human being, with the robot apparatus autonomously selecting its behavior, have so far been proposed. In a majority of these proposals, the robot apparatus may be caused to act as the request from the human being is taken into account, by the human being explicitly transmitting his/her intention to the robot apparatus by a speech command or using a controller.

Such apparatus has also been proposed in which, instead of a counterpart, as a user (subject of communication), explicitly imparting his/her intention, the system infers the feeling of the user (subject of communication) and the function he/she desires to switch the functions. In any of these apparatus, only the function of switching the functions of the robot apparatus in consideration of the results of inference of the counterpart side feeling, with the robot apparatus then performing absolutely faithful behavior for the counterpart.

[Patent Publication 1] Japanese Laid-Open Patent Publication 2001-157980

However, with the robot apparatus, configured for selecting the behavior taking only the own state into account, the state of the subject of communication or interaction is not taken into account, if there lack explicit commands. Hence, if it is desired to realize the spontaneous communication between the robot apparatus and the counterpart, as a human being, it is usually the human being that has to determine which interaction is to be had, in keeping up with the state transition of the robot apparatus.

That is, such a robot apparatus, as a partner for the human being, capable of taking his/her complacence into account, in which, instead of the human being observing the switched behavior of the human being, and feeling solaced from time to time, the robot apparatus positively observes the state of the human being to make an endeavor to solace his/her mind, as a result of which the state of mind of the counterpart is healed, is difficult to implement with the above-described behavior selecting architecture designed to satisfy only the self state.

On the other hand, with the robot apparatus, selecting the behavior or switching the functions as only the counterpart state is taken into account, the self state is not considered, so that, if the state of the robot apparatus itself is imperiled, such that the behavior of protecting the robot apparatus itself is to be prioritized, the robot apparatus cannot select the behavior of self protection. Moreover, if there is no human being, as counterpart, whose intention is to be considered, in a near-by place, the robot apparatus is unable to select its behavior. Stated differently, the robot apparatus is unable to adaptively switch between the function of the counterpart and that of the robot apparatus itself, in such a manner that, when the self state is bad or there is no counterpart in a near-by site, the autonomous behavior is selected to take the state of the robot apparatus itself into account, and that, in case the self state is satisfied or the state of the counterpart is verified to be extremely bad, the self behavior is selected such as to take the state or the feeling of the counterpart into account to provide for a better state of the counterpart. On the other hand, if the robot apparatus has only the function of selecting the self state in consideration of the counterpart feeling, the apparatus imparts an impression that it is merely a faithful slave for the human being.

If the ‘waywardness’, or the ‘intention of the robot apparatus itself’ resulting from the autonomous behavior decision, based on the self inner state, as a merit of the entertainment robot, can be realized, the behavior of the robot apparatus can be made to approach to a behavior pattern of living bodies in the actual world.

### SUMMARY OF THE INVENTION

In view of the above-depicted state of the art, it is an object of the present invention to provide a behavior control system and a behavior control for the robot apparatus, having the function of adaptively switching between the behavior selection standard taking the self state into account, as required of the autonomous robot apparatus, and the behavior selection standard taking the counterpart state into account, depending on a prevailing situation.

For accomplishing the above object, the present invention provides a behavior control system in a robot apparatus, adapted for acting autonomously, comprising activation level calculating means for calculating an activation level indicating the priority of execution of behaviors stated in a plurality of behavior describing models, and behavior selection means for selecting at least one behavior based on the activation level. The activation level calculating means includes self activation level calculating means for calculating a self activation level, indicating the priority of execution of respective behaviors with the self as reference, counterpart activation level calculating means for calculating a counterpart activation level, indicating the priority of execution of the behaviors, with a counterpart, as subject of interaction, as reference, and activation level integrating means for calculating the activation level based on the self activation level and the counterpart activation level.

According to the present invention, the activation level, indicating the priority of execution of each behavior, is found by integrating the self activation level, as found with the self state as reference, and the counterpart activation level, as found with the state of the counterpart, such as a user (human being), as a subject of interaction or communication, so that, in behavior selection, neither the measly behavior which may appear as wayward and arbitrary, taking only the self state into account without taking heed of the other, nor the measly faithful behavior, taking only the counterpart state into account without taking heed of the self, is selected, but the state of both the self and the counterpart is taken into account.

The present invention also provides a behavior control system in a robot apparatus, adapted for acting autonomously, comprising external stimulus recognizing means for recognizing external stimuli to the robot apparatus from the sensor information, self state management means for supervising the self state including at least plural sorts of self inner states, counterpart state management means for supervising the counterpart state including at least plural sorts of counterpart inner states, and parameter calculating means for calculating a parameter determining which of the self state and the counterpart state is to be made much of. Each of the behaviors is a preset external stimulus and the preset self state associated with each other and a preset external stimulus and the preset counterpart state associated with each other. The self activation level calculating means calculates the self activation levels of respective behaviors based on preset external stimuli associated with the respective behaviors and on the preset self state. The counterpart activation level calculating means calculates the counterpart activation levels of respective behaviors based on preset external stimuli associated with the respective behaviors and on the preset counterpart state. The activation level integrating means integrates the self activation levels and the counterpart activation levels based on the parameter. Thus, the character of the robot apparatus may be changed freely, by changing the setting of the parameter determining whether the self state is to be made much of so that the robot apparatus is wayward or the counterpart state is to be made much of so that the robot apparatus is more benign to others.

The self state may include a plurality of sorts of self inner states and a plurality of sorts of self feelings and the counterpart state includes a plurality of sorts of counterpart inner states and a plurality of sorts of counterpart feelings. The self feeling and the counterpart feeling may be included in the self state and in the counterpart state, so that such behavior may be selected which takes the self feeling and the counterpart feeling into account.

The parameter calculating means may calculate the parameters based on the self state, such that the parameter may be set so as to emphasize the counterpart state when the self state is good and so as to emphasize the self state when the self state is bad.

The parameter calculating means may calculate the parameters based on the counterpart state, such that the parameter may be set so as to emphasize the self state when the counterpart state is good and so as to emphasize the counterpart state when the counterpart state is bad.

The self activation level calculating means may find a self instinct value indicating the instinct for each behavior based on the current self state associated with each behavior and also may find an anticipated change in self satisfaction based on an anticipated change in the self state indicating a changed self state anticipated on the basis of the external stimuli. The self activation level calculating means may calculate the self activation level associated with each behavior based on the self instinct value and on the anticipated change in the self state. The counterpart activation level calculating means may find a counterpart instinct value indicating the instinct for each behavior based on the current counterpart state associated with each behavior and also find an anticipated change in counterpart satisfaction based on an anticipated change in the counterpart state indicating a changed counterpart state anticipated on the basis of the external stimuli. The counterpart activation level calculating means may calculate the counterpart activation level associated with each behavior based on the counterpart instinct value and on the anticipated change in the counterpart state. In this manner, a wide variety of behaviors may be demonstrated which are not unique against self and counterpart states that may be variable responsive to environments or communication with others or to external stimuli.

The self activation level calculating means may find the current self satisfaction from the current self state and calculate the self activation level for each behavior based on the self satisfaction, the anticipated changes in self satisfaction and on the self instinct value. The counterpart activation level calculating means may find the current counterpart satisfaction from the current counterpart state and calculate the counterpart activation level for each behavior based on the counterpart satisfaction, the anticipated changes in counterpart satisfaction and on the counterpart instinct value. The self activation level or the counterpart activation level may be set so as to depend strongly on e.g. the self state (self instinct) or to the counterpart inner state (counterpart instinct) or on external stimuli (anticipated change in self satisfaction, anticipated self satisfaction, anticipated change in counterpart satisfaction or anticipated counterpart satisfaction).

The present invention also provides a behavior control method in a robot apparatus, adapted for acting autonomously, comprising an activation level calculating step for calculating an activation level indicating the priority of execution of behaviors stated in a plurality of behavior describing models, and a behavior selection step for selecting at least one behavior based on the activation level. The activation level calculating step includes a self activation level calculating step of calculating a self activation level, indicating the priority of execution of respective behaviors with the self as reference, a counterpart activation level calculating step of calculating a counterpart activation level, indicating the priority of execution of the behaviors, with a counterpart, as subject of interaction, as reference, and an activation level integrating step of calculating the activation level based on the self activation level and the counterpart activation level.

With the behavior control method and system for a robot apparatus, acting autonomously, the activation level, indicating the priority of execution of each behavior, stated in plural behavior describing modules, is calculated and, in calculating the activation level, at least one behavior is selected with the self state as reference. In calculating the activation level, the self activation level, indicating the priority of execution of each behavior, with the self state as reference, and the counterpart activation level, indicating the priority of execution of each behavior, with the counterpart state as reference, are calculated, and the activation level is calculated based on the self activation level and the counterpart activation level. This enables behavior selection, taking both the self state and the counterpart state into account, from the self activation level calculated only from the self state and from the counterpart activation level calculated only from the counterpart state. In this manner, the robot apparatus may be caused to act waywardly or benignly, by emphasizing the self state or the counterpart state, respectively.

### BRIEF DESCRIPTION OF THE DRAWINGS

FIG. 1 is a perspective view of a robot apparatus embodying the present invention.

FIG. 2 is a schematic block diagram showing the functional structure of the robot apparatus embodying the present invention.

FIG. 3 is a block diagram showing the structure of a control unit, embodying the present invention, in further detail.

FIG. 4 is a functional block diagram showing a behavior selection control system portion of the control unit, embodying the present invention, configured for calculating the activation level AL associated with each behavior for outputting behavior output accordingly.

FIG. 5 is a functional block diagram showing the activation level computing unit in the behavior selection control system.

FIG. 6 schematically shows a self inner state model supervised by a self inner state management unit 91 of the robot apparatus 1.

FIGS. 7a to 7c schematically show an emotional space Q showing a feeling model in the present embodiment.

FIG. 8 schematically shows the processing flow for calculating the activation level AL by the activation level calculating unit from the external stimuli and the changes in the inner states.

FIG. 9 is a graph showing the relation between the inner state and the instinct, taking respective components of the inner state vector IntV and respective components of the instinct vector on the abscissa and on the ordinate, respectively.

FIG. 10 shows calculated data of the activation level in an activation level calculating database.

FIG. 11 is a graph showing the relation between the inner state and the satisfaction, taking IntV_NOURISHMENT and the satisfaction S NOURISHMENT for the inner state ‘state of nourishment’ on the abscissa and on the ordinate, respectively.

FIG. 12 is a graph showing the relation between the inner state and satisfaction, taking intV_FATIGUE (fatigue) and the satisfaction S_FATIGUE for the inner state ‘fatigue’ on the abscissa and on the ordinate, respectively.

FIGS. 13a and 13b show examples of the activation level computing data structure in case of finding anticipated changes in the inner states ‘state of nourishment’ (NOURISHMENT) and ‘fatigue’ (FATIGUE), respectively.

FIG. 14 illustrates a method for linear interpolation of one-dimensional external stimuli.

FIG. 15 illustrates a method for linear interpolation of two-dimensional external stimuli.

FIG. 16 shows an example of updating an anticipated change in the inner states of two-dimensional external stimuli.

FIG. 17 is a graph showing the relation between the inner states and the instinct, taking respective components of the inner state vector IntV and respective components of the instinct vector InsV on the abscissa and ordinate, respectively.

FIG. 18 shows calculated data of the activation level in an activation level calculating database.

FIG. 19 is a graph showing the relation between the inner state and satisfaction, taking intV_NOURISHMENT (state of nourishment) and the inner state ‘nourishment’ on the abscissa and on the ordinate, respectively.

FIG. 20 is a graph showing an ego-parameter used in the behavior control selection system embodying the present invention.

FIG. 21 schematically shows the functional configuration of the behavior control system of a robot apparatus embodying the present invention.

FIG. 22 schematically shows an object configuration of the behavior control system of a robot apparatus embodying the present invention.

FIG. 23 schematically shows the configuration of the situation dependent behavior control embodying the present invention.

FIG. 24 schematically shows how the situation dependent behavior layer is made up by plural schemas.

FIG. 25 schematically shows a tree structure of schemas in the situation dependent behavior layer.

FIG. 26 schematically shows a mechanism for controlling the usual situation dependent behavior in the situation dependent behavior layer.

FIG. 27 schematically shows the structure of a schema in a reflexive behavior unit.

FIG. 28 schematically shows a mechanism for controlling the reflexive behavior in the reflexive behavior unit.

FIG. 29 schematically shows class definition of schemas used in the situation dependent behavior layer.

FIG. 30 schematically shows the functional structure of a class in the in the situation dependent behavior layer.

FIG. 31 illustrates the re-entrant property of a schema.

### DESCRIPTION OF THE PREFERRED EMBODIMENTS

Referring to the drawings, specified embodiments of the present invention are explained in detail with reference to the drawings. In the embodiments illustrated, the present invention is applied to a robot apparatus, such as a pet type robot or a humanoid robot, simulating the living body and capable of having interactions with a user. Here, the structure of such a robot apparatus is first explained, a behavior selecting and controlling system for selecting an autonomously demonstrated behavior in a control system for the robot apparatus is then explained, and finally the control system for the robot apparatus, inclusive of such behavior selecting and controlling system, is explained.

(A) Structure of Robot Apparatus

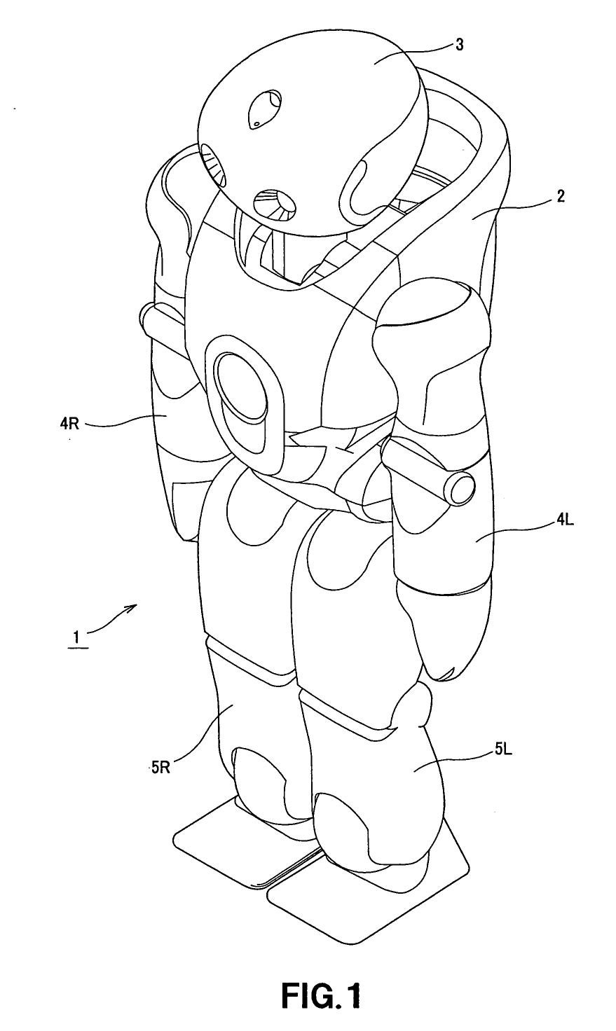

FIG. 1 is a perspective view showing the appearance of the present embodiment of a robot apparatus 1. Referring to FIG. 1, the robot apparatus 1 includes a body trunk unit 2, to which are connected a head unit 3, left and right arm units 4R/L and left and right leg units 5R/L. It is noted that R and L denote suffixes indicating left and right, respectively, hereinafter the same.

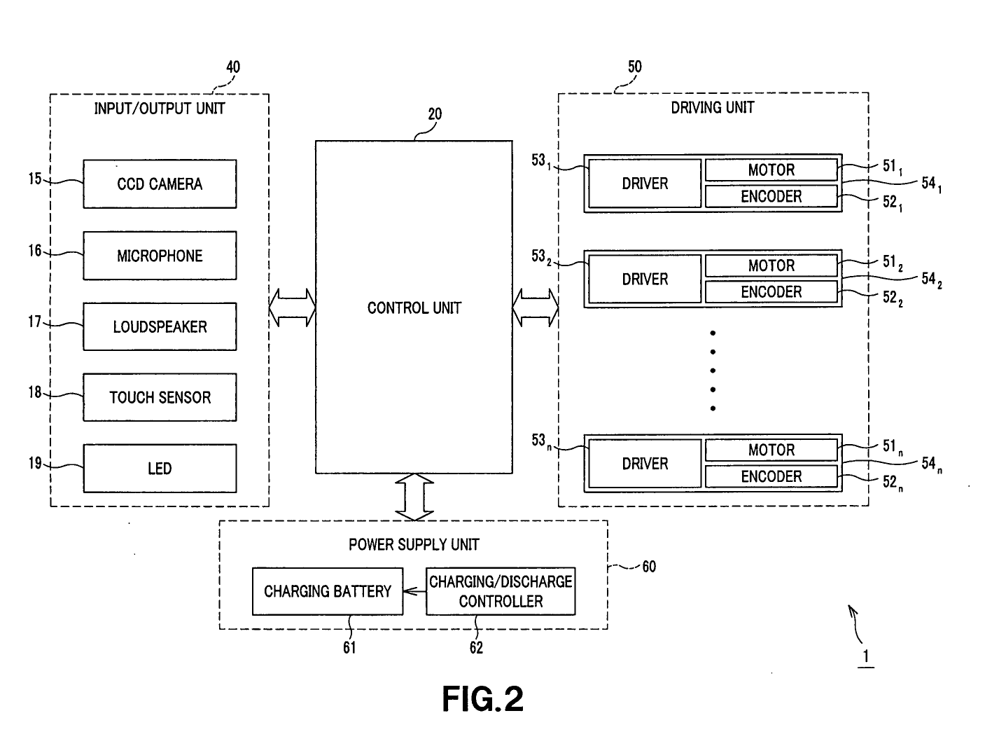

FIG. 2 is a schematic block diagram showing the functional structure of the robot apparatus 1 of the present embodiment. Referring to FIG. 2, the robot apparatus 1 is made up by a control unit 20 for managing comprehensive control of the entire operation and other data processing, an input/output unit 40, a driving unit 50, and a power supply unit 60. These component units are hereinafter explained.

The input/output unit 40 is includes a CCD camera for capturing an outside state, as a member equivalent to an eye of a human, a microphone 16, equivalent to an ear of the human, and a variety of sensors, such as a touch sensor 18, electrically detecting the preset pressure to sense the touch by the user, a distance sensor for measuring the distance up to a forwardly located object, and a gyro sensor, equivalent to five senses of the human, as input units. The robot apparatus 1 also includes, as output units, a loudspeaker 17, provided to the head unit 3, and equivalent to the mouse of the human, and an LED indicator 19 (eye lamp), provided at a location corresponding to the eye of the human and expressing the feeling or state of visual recognition. These output units are capable of expressing the user feedback from the robot apparatus 1 in a form different from mechanical movement patterns by legs, such as by voice or by flickering of the LED indicator 19.

For example, plural touch sensors 18 may be provided to preset locations of the scalp of the head unit, and contact detection in each touch sensor 18 may be exploited in a compounded manner to detect behaviors from the user, such as ‘stroking’, ‘hitting’ or ‘patting’ on the head part of the robot apparatus 1. For example, if it is detected that a certain number of pressure sensors have been acted upon sequentially one after another at an interval of preset time, this state is determined to be the ‘stroked’ state. If a certain number of pressure sensors have been acted upon sequentially at shorter time intervals, this behavior is determined to be a ‘hit’ state. The inner state is changed accordingly. Such change in the inner state may be expressed by the aforementioned output units.

The driving unit 50 is a functional block for realization of the movements of the main body unit of the robot apparatus 1, in accordance with a preset movement pattern, as commanded by the control unit 20, and is a subject controlled by behavior control. The driving unit 50 is a functional module for realization of the degrees of freedom in each joint of the robot apparatus 1, and is made up by plural driving units 54₁ to 54ₙ provided to respective axes of the pitch, roll and yaw in each joint. These driving units 54₁ to 54ₙ are made up by motors 51₁ to 51ₙ, carrying out rotational movements about preset axes, encoders 52₁ to 52ₙ for detecting rotational positions of the motors 51₁ to 51ₙ, detecting the rotational positions of the motors 51₁ to 51ₙ, and drivers 53₁ to 53ₙ for adaptively controlling the rotational positions or rotational speeds of the motors 51₁ to 51ₙ based on outputs of the encoders 52₁ to 52ₙ.

Although the present robot apparatus 1 walks on two legs, it may also be constructed as a mobile robot apparatus, walking on four legs, depending on the combination of the driving units.

The power supply unit 60, as its name implies, is a functional module for feeding the power for respective electrical circuits in the robot apparatus 1. The present robot apparatus 1 is of the autonomous driving type, employing a battery. The power supply unit 60 is made up by a charging battery 61, and a charging/discharge controller 62 for supervising the charging/discharge state of the charging battery 61.

The charging battery 61 is formed as a ‘battery pack’ composed of plural lithium ion secondary cells, enclosed in a cartridge.

The charging/discharge controller 62 comprehends the residual capacity of the battery 61, by measuring e.g. the terminal voltage, charging/discharge current or the ambient temperature of the battery 61, to determine the charging start time and the charging termination time of the battery 61. The charging start time and the charging termination time are notified to the control unit 20 for use as a trigger for the robot apparatus 1 to start and terminate the charging operations.

The control unit 20 is equivalent to the ‘brain’ and is loaded on, for example, a head or trunk part of the main body unit of the robot apparatus 1.

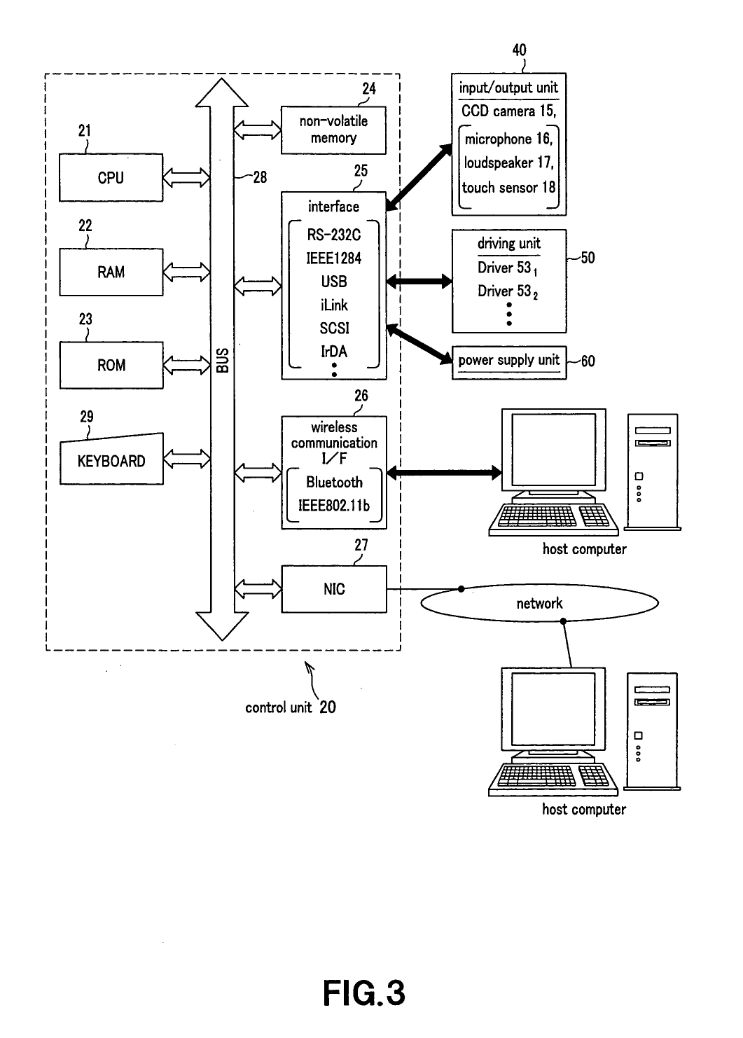

FIG. 3 depicts a block diagram showing the structure of the control unit 20 in further detail. Referring to FIG. 3, the control unit 20 is made up by a CPU (central processing unit) 21, as a main controller, connected over a bus 28 to a memory, circuit components or peripheral devices. This bus is a common path for signal transmission, made up e.g. by a data bus, an address bus or a control bus. The respective devices on the bus 28 are accorded intrinsic addresses (memory addresses or I/O addresses). By specifying the addresses, the CPU 21 is able to communicate with specified devices on the bus 28.

A RAM (random access memory) 22 is a rewritable memory, formed by a volatile memory, such as DRAM (dynamic random access memory), and is used for loading a program code, run by the CPU 21 or for temporarily storing work data by a program being executed.

A ROM (read-only memory) 23 is a read-only memory for permanently storing programs or data. The program codes, stored in the ROM 23, may be exemplified by a self-diagnosis program, sun on power up of the robot apparatus 1, and an operation control program, prescribing the operation of the robot apparatus 1.

The control programs for the robot apparatus 1 includes, for example, a ‘sensor input/recognition processing program’ for recognizing sensor inputs of, for example, a camera 15 or a microphone 16, for recognition thereof as a symbol, a ‘behavior control program’ for controlling the behavior of the robot apparatus 1, based on the sensor input and the preset behavior control program, as the program takes charge of storage operations, such as short-term storage or long-term storage, as later explained, and a ‘driving control program’ for controlling the driving of each joint motor or a speech output of the loudspeaker 17 in accordance with the behavior control program.

A non-volatile memory 24 is formed by e.g. an electrically erasable and rewritable memory device, such as EEPROM (electrically erasable and programmable ROM), and is used for non-volatile retention of data which is to be updated sequentially. The data to be updated sequentially may be exemplified by a secret key, other security information and device control programs to be installed after shipment.

An interface 25 is a unit for connection to equipment outside the control unit 20 for enabling data exchange operations. The interface 25 is responsible for data inputting/outputting with e.g. the camera 15, microphone 16 or with the loudspeaker 17. The interface 25 is responsible for data inputting/outputting with e.g. drivers 531 to 53n in the driving unit 50.

The interface 25 may include general-purpose interfaces for connection to peripheral equipment, such as serial interface, e.g. RS (Recommended Standard)-232C, parallel interface such as IEEE (Institute of Electrical and Electronics Engineers) 1284, USB (Universal Serial Bus) interface, i-LINK (IEEE1394), SCSI (Small Computer System Interface) or a memory card interface (card slot) for coping with a PC card or a memory stick, in order to take charge of transferring programs or data with locally connected outside equipment.

In a modification, the interface 25 may be provided with infrared communication (IrDA) interface, in order to have wireless communication with the outside equipment.

The control unit 20 may also include a wireless communication interface 26 or a network interface card (NIC) 27, in order to have proximity wireless data communication, such as Bluetooth, or data communication with variable outside host computers via a wireless network, such as IEEE 802.11b, or over a wide-area network, such as the Internet.

By such data communication between the robot apparatus 1 and the host computer, it is possible to remoter-control or calculate complex behavior control of the robot apparatus 1, with use of remote computer resources.

(B) Method for Controlling the Behavior of the Robot Apparatus

The behavior controlling method for the robot apparatus of the present embodiment is now explained in detail. The robot apparatus 1 of the present embodiment includes a behavior selection control system capable of selecting a behavior taking into account both the state of the robot apparatus itself and the state of the user as a subject of interaction or communication, referred to below as a counterpart (another party). The state of the robot apparatus itself denotes plural sorts of the inner state, such as ‘fatigue’, ‘pain’ or ‘drowsiness’ of the robot apparatus, referred to below as ‘self inner state’, and plural sorts of the feeling, such as happiness or sorrow, referred to below as ‘self emotion’. In similar manner, the state of the counterpart denotes plural sorts of the inner state, such as ‘fatigue’, ‘pain’ or ‘drowsiness’ of the counterpart, referred to below as ‘inner state of the counterpart’ or ‘counterpart inner state’, and plural sorts of the feeling of the counterpart, as surmised by the robot apparatus, referred to below as ‘emotion of the counterpart’ or ‘counterpart emotion’. These plural sorts of the self inner state, self emotion, counterpart inner state and the counterpart emotion, are rendered into the numerical form and supervised as state parameters.

The present behavior selection control system is responsive to the self state, state of the counterpart, state of the surrounding and commands/behaviors from the user, to autonomously select and output the behavior. Specifically, the system calculates an activation level AL, indicating the priority of execution of the respective behaviors, and selects the behavior for execution based on this activation level AL. Here, the method for controlling the behavior selection until the behavior emanating from the self state, state of the counterpart and from the stimulus from outside, in the behavior control of the robot apparatus, is explained, and the overall structure of the control system for the robot apparatus will be explained subsequently.

As regards the algorithm for autonomously selecting the behavior which is in meeting with the self state of the robot apparatus, a behavior selection control system, enabling the simultaneous selection of plural behaviors of a high activation level, from the instinct and the degree of satisfaction, as calculated from the inner state of the robot apparatus, and from the predicted degree of satisfaction, as defined by the stimuli from outside, insofar as the resources are not overlapped, has been proposed by the present Assignee (see, for example, the Japanese Patent Application 2003-65587). This behavior selection control system is made up by an object supervising the inner state of the robot apparatus (state management unit: internal state model (ISM)), a database referred to for evaluating the inner state, that is, for calculating the inner state in terms of the degree of the instinct and the degree of satisfaction (activation level schema library (ALSchemaLib)), and a set of behaviors enabling the inner states to be met.

With the behavior selection control system of the present embodiment, the states of the counterpart, such as a human being, as a subject of the interaction, are estimated and entered to the above-described behavior selection control system, designed for autonomous selection of the behavior which is in meeting with the self state, thereby achieving the behavior which takes into account not only the self state but also the counterpart state. That is, the behavior selection control system of the present embodiment further includes an object for supervising the state of the counterpart, acquired on estimation (counterpart state supervising unit: Inter-ISM), a counterpart emotion supervising unit for estimating and supervising the emotion of the counterpart, a database for evaluating the inner state of the counterpart (Inter-ALSchemaLib) and a set of behaviors that may be taken by the robot apparatus in order to produce changes in the inner state of the counterpart. The control system also includes an object for supervising a parameter determining in which proportion the activation level AL calculated for the self state and that calculated for the state of the counterpart are to be reflected in the behavior selection.

(1) Overall Structure of the Behavior Selection Control System

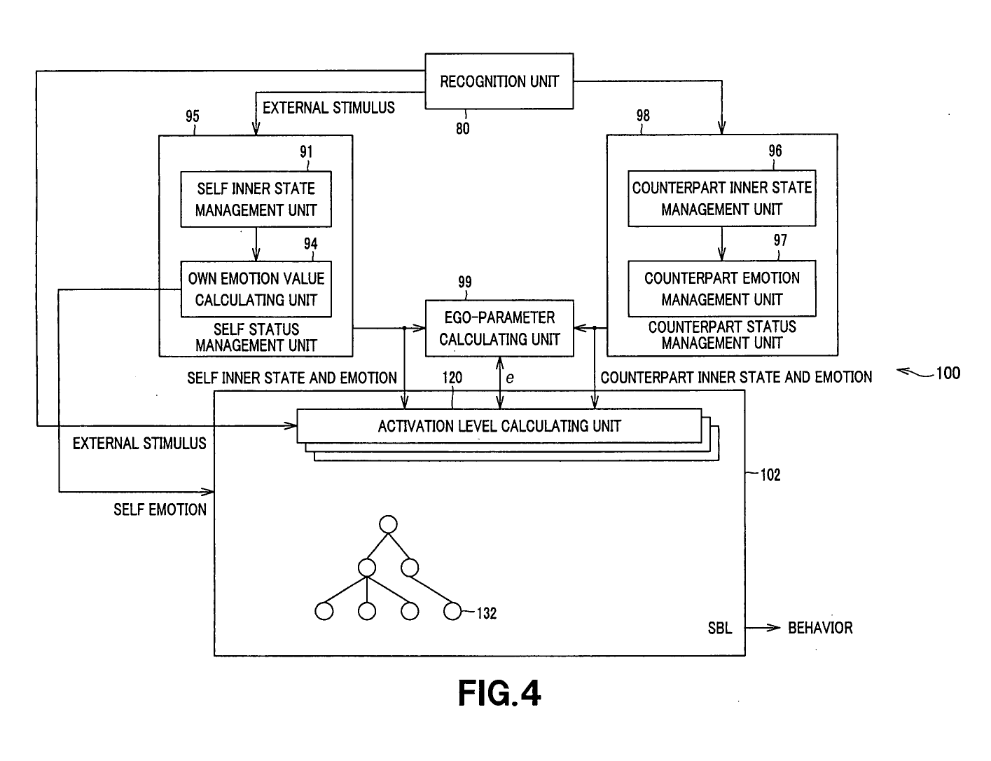

The behavior selection control system of the present embodiment is now explained in detail. FIG. 4 depicts a block diagram showing the behavior selection control system of the robot apparatus. Referring to FIG. 4, the behavior selection control system 100 of the present embodiment includes a self state management unit 95 for supervising the inner state and the emotion composed of plural sorts of the feeling of the robot apparatus itself, arranged in the form of a mathematical model, and a counterpart state management unit 98 for supervising the inner state and the emotion composed of plural sorts of the feeling of the counterpart as a subject of interaction or communication with the robot apparatus. The behavior selection control system also includes an ego-parameter calculating unit 99 for calculating a parameter, later explained, for demonstrating a behavior which is based on the self state or a behavior which is based on the state of the counterpart, based on the output results of the self state management unit 95 and the counterpart state management unit 98. The behavior selection control system also includes a situation-dependent behavior layer 102 (situated behavior layer: SBL) for calculating the activation level AL, indicating the priority in executing the respective behaviors, for plural behaviors, based on the output results of the self state management unit 95 and the counterpart state management unit 98, stimuli from outside, supplied from a recognition unit 80, and the aforementioned parameter, and for selecting and outputting a behavior or plural behaviors, for which there occurs no competition for resources, based on the activation level AL.

Out of the results of recognition by the recognition unit 80, such as the speech inputting unit or a picture recognition unit, sensor values (external stimuli) needed for calculating the self inner state or the emotion, are extracted and entered to the self state management unit 95. This self state management unit 95 includes a self inner state management unit 91 for calculating the external stimuli as recognized by the recognition unit 80 in terms of the self inner state and supervising the so calculated state, and a self emotion value calculating unit 94 for calculating the self feeling state (self-emotion) responsive to a self inner state and the external stimuli, and routes the self feeling state (self-emotion) to the ego-parameter calculating unit 99 and to the SBL 102. The self-state, supplied to the ego-parameter calculating unit 99 and to the SBL 102, is made up by the self inner state and the self emotion, the self inner state is a set of self inner state parameters (self inner state vector) comprised of a plural number of sorts of inner states, rendered in the numerical form., and the self inner state is a set of feeling parameters (self emotion vector) comprised of a set of a plural number of sorts of feelings, rendered in the numerical form. The self state management unit 95 supervises a set of self state parameters, composed of the set of the self inner state parameters and the set of the plural number of sorts of self feelings, as the self state.

The counterpart state management unit 98 includes a counterpart inner state management unit 96, supplied from a variety of recognition units 80 with sensor values (external stimuli), as necessary for calculating the inner state of the counterpart, and estimating the inner state of the counterpart from the recognized results to supervise the so estimated inner state, and a counterpart emotion management unit 97, estimating the feeling state of the counterpart (emotion value of the counterpart) based on the recognized results of the various recognition units 80 to supervise the so estimated feeling state. The state of the counterpart, supplied to the ego-parameter calculating unit 99 and to the SBL 102, is made up by the inner state and the emotion of the counterpart. The inner state of the counterpart is a set of plural inner state parameters (inner state vector of the counterpart), comprised of plural sorts of the feeling, rendered in the numerical form, while the emotion of the counterpart is a set of plural feelings (emotion vector of the counterpart) in which plural feeling sorts are rendered in the numerical form. The self state management unit 95 supervises the set of parameters of the counterpart state, made up by the set of parameters of the self inner states, and the set of parameters of the self feeling, as the counterpart state.

The SBL 102 is comprised of a tree structure (schema tree, behavior set) of plural behavior describing modules (schemas) 132, describing component behaviors. Each schema 132 includes an activation level calculating unit 120 for calculating the activation level AL indicating the priority in execution of the behaviors stated in the schema itself.

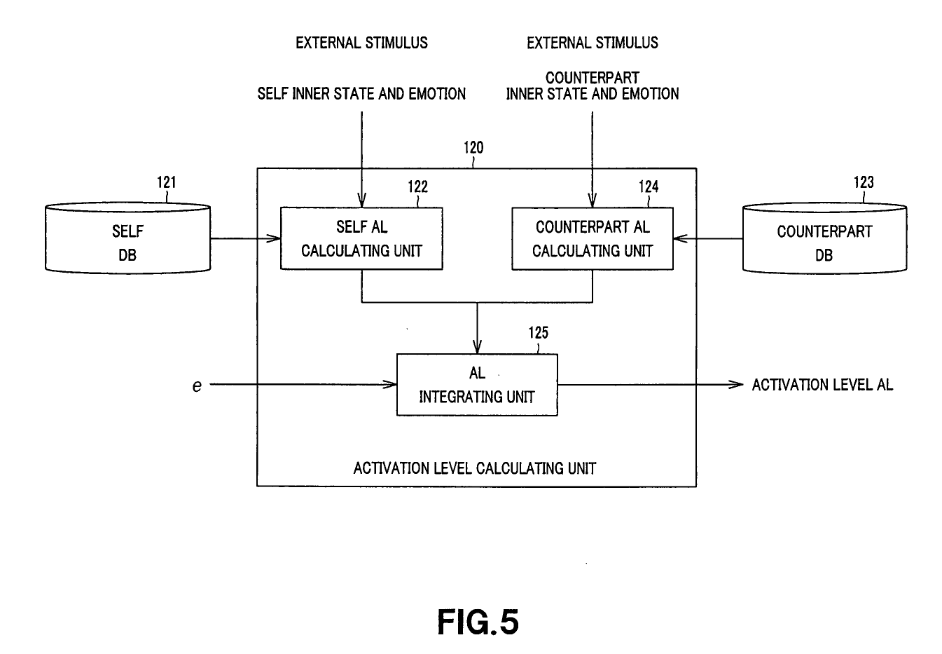

Referring to FIG. 5, the activation level calculating unit 120 includes a self AL calculating unit 122 for calculating the self AL by referring to an own database (referred to below as self DB) as later explained. In this self DB, there are stored parameters and data needed for calculating the self activation level (termed ALself) indicating the priority in executing each behavior, referenced to the robot apparatus itself, based on the self emotion and the self inner state as entered from the self state management unit 95 and on the external stimuli as entered from a recognition unit 11. The activation level calculating unit 120 also includes a counterpart AL calculating unit 124 for calculating the counterpart AL by referring to a database for the counterpart (referred to below as counterpart DB) as later explained. In this counterpart DB, there are stored parameters and data needed for calculating the counterpart activation level (termed ALother) indicating the priority in executing each behavior, referenced to the counterpart, based on the emotion and the inner state of the counterpart as entered from the recognition unit 80. The activation level calculating unit also includes an AL integration unit 125 for integrating the ALself and the ALother by the parameter calculated by the ego-parameter calculating unit 99 to calculate the ultimate activation level AL used for behavior selection.

In the self DB 121, there are stored a parameter for evaluating the self inner state to determine the shape of the evaluation function for calculating the value of the instinct and the degree of self satisfaction, and the estimated change in the inner state of the counterpart, associated with the external stimuli, and which is used for calculating the ALself. In the DBother, there are stored a parameter for evaluating the inner state of the counterpart to determine the shape of the evaluation function for calculating the value of the instinct and the degree of self satisfaction of the counterpart, and the estimated change in the inner state of the counterpart, associated with the external stimuli, and which is used for calculating the ALother. These databases may be referenced not only by the self AL calculating unit 122 and by the counterpart AL calculating unit 124, but also by other modules, such as ego-parameter calculating unit 99, as necessary.

The SBL 102 selects a schema having the highest activation level AL as calculated by the activation level calculating unit 120, or plural schemas, beginning from the schema having the highest activation level AL, as long as the resources do not compete with one another, and outputs the behavior stated in the so selected schema 132.

The parameter calculated by the ego-parameter calculating unit 99 is a parameter for determining to which extent the self state is made much of or the state of the counterpart is made much of, in the behavior selection. This parameter is referred to in the present specification as an egoistic parameter (abbreviated to ego-parameter).

The ALself indicates to which extent the robot apparatus is desirous to execute a behavior stated in the component behavior (priority of execution referenced to robot's self), while the ALother is an estimated value indicating to which extent a counterpart is desirous to have the robot apparatus execute the behavior stated in the component behavior (priority of execution referenced to the counterpart). A behavior selection unit, not shown, such as a root schema, in the SBL 102, selects a schema stating one or more component behaviors having the high activation level AL, based on the activation level AL, integrated from the ALself and ALother, based on the ego-parameter. The so selected schema outputs the component behavior stated therein. That is, each schema 132 calculates the activation level AL, by the own activation level calculating unit 120, to select the schema having a high value of the activation level AL to output the corresponding component behavior, whereby the robot apparatus demonstrates the behavior.

In the present embodiment, a given schema includes an AL calculating unit 120, calculating the ALself based on the self inner state and the external stimuli as defined in the schema, that is, associated with the component behavior stated in the schema, calculating the ALother based on the inner state of the counterpart and the external stimuli, associated with the same component behavior, and outputting a value integrated from the ALself and ALother by the ego-parameter as the activation level AL. It is, however, also possible to provide two schemas, stating the same component behavior, with the schemas separately calculating the ALself and ALother and multiplying the so calculated ALself and ALother with the ego-parameter to give the own activation levels AL. The schema having the higher value of the activation level AL is selected.

Thus, in the behavior selection control system of the present embodiment, each schema calculates the activation level AL, and the behavior demonstrated on the basis of the so calculated activation level AL is selected. In calculating the activation level AL, the ALself, calculated on the basis of the own state, and the ALother, calculated on the basis of the state of the counterpart, are found, and are summed together by weighted addition, using an ego-parameter determining which of the own state and the state of the counterpart are made much of, in order to enable behavior selection more appropriate for the human being or higher in entertainment properties, as shown in FIG. 5. For example, if the inner state of the robot apparatus itself is proper and in good humor, the ego-parameter may be set so as to make much of the inner state of the counterpart, in such a manner that the inner state or the emotion of the counterpart may be inferred and in order that the behavior which will satisfy the inner state of or please the counterpart may be selected more readily.

The method for calculating the activation level AL in the present embodiment is now explained in detail in the sequence of the method for supervising the own state and the state of the counterpart, the method for calculating the ALself and the ALother, the method for calculating the ego-parameter and the method for integrating the ALself and the ALother.

(2) Method for Supervising the Own State

The robot apparatus may form a self model to supervise the own state by supervising the self inner state and the own feeling state, rendered in the numerical form, within the robot apparatus itself. The self state management unit 95, supervising the own state, supervises the self inner state in the self inner state management unit 91, while supervising the emotion, composed of plural feelings, in the self emotion value calculating unit 94.

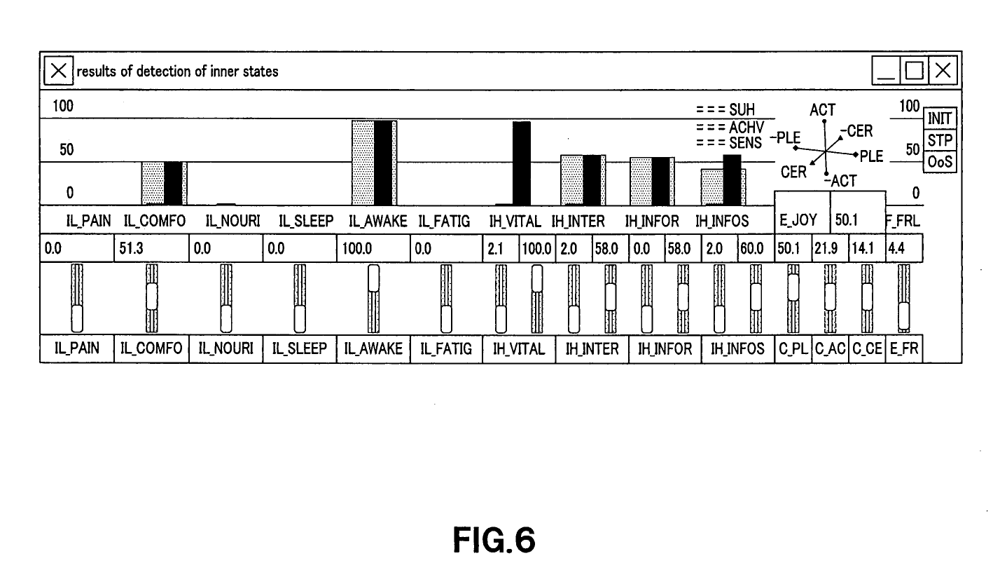

FIG. 6 schematically shows a self inner state model, supervised by the self inner state management unit 91. The inner states of the robot apparatus itself may be exemplified by, for example, the FATIGUE calculated on the basis of, for example, the number of cumulative walking steps or of the power consumption, PAIN indicating the magnitude of the joint torque, NOURISHMENT indicating the residual battery capacity, and SLEEP varied with the length of the activation time duration.

In addition, definition may be made of the AWAKENING, indicating the reciprocal of sleep (for example, AWAKENING=100−SLEEP), COMFORT calculated by the number of times a contact sensor has been pressed for longer time, VITALITY indicating the reciprocal of fatigue (for example, VITALITY=100−FATIGUE), INTERACTION calculated on the basis of the time during which the schema in dialog has been active (time duration of dialog executed), the volume of information (INFORMATION) and information co-owning (INFOSHARE), calculated on the basis of the amount acquired of the information on the counterpart (e.g. name or favorite food).

The volume of the information (INFORMATION) is an inner state which is set so that, in case the amount of the information acquired e.g. from the counterpart is small, the desire to learn more about the counterpart is enhanced. The information co-owning (INFOSHARE) indicates an inner state which is set so that, in case the amount of the information acquired e.g. from the counterpart increases, the desire to show the fact of such increase to the counterpart.

In the present embodiment, six of the ten inner states, to which have been appended indexes 1L (low level), that is, PAIN, COMFORT, NOURISHMENT, SLEEP, AWAKENING and FATIGUE, represent the inner states determined in dependence upon the results of evaluation of the physical sensor information (external stimuli) loaded on the robot apparatus. That is, the values of these six inner states are uniquely determined on the basis of the physical states of the robot apparatus.

On the other hand, the four inner states to which have been appended indexes 1L (low level), that is, vitality (VITALITY), interaction (INTERACTION), volume of information (INFORMATION) and the information co-owning (INFOSHARE), represent the inner states that cannot be determined if solely the physical sensor information (external stimuli) loaded on the robot apparatus is resorted to. Specifically, these four inner states represent the inner states the values of which may be changed or evaluated from a virtual recognition unit formed by exploiting the software technique. For example, a software object for monitoring the dialog time duration is provided and, if dialog was made, the amount of change of the inner state: information volume (INTERATION) is directly sent to the internal state model (ISM). The robot apparatus demonstrates a behavior for changing the inner state in the direction of increasing the degree of satisfaction obtained from the information volume (INTERATION), such as by further speaking to the counterpart in case the information acquired form the counterpart is small, or by stopping the dialog in case the sufficient information has been acquired from the counterpart, as later explained.

Although the above ten inner states are defined and set, in the present embodiment, it is of course possible to set inner states for calculating the desire or the degree of satisfaction as necessary. Meanwhile, the inner states may be rendered dependent only on the results evaluated from the physical sensor information, or dependent on the results of evaluation by virtual sensor, as described above. These methods for finding the inner states may be suitably set in dependence upon the sorts of the inner states defined.

As a model of the feeling states of the robot apparatus 1 itself, supervised by the self emotion value calculating unit 94, it is possible to use a feeling model in which six basic emotions, that is, joy (JOY), anger (ANGER), sadness (SADNESS), fear (FEAR), disgust (DISGUST) and surprise (SURPRISE), are distributed in a state space. In the present embodiment, the feeling indication the normal (NEUTRAL) is provided, in addition to these six feelings, as the sic basic feelings. This neutral is of such a value which, in case the sum of the other feeling values is not larger than a preset value, is increased complementarily to give a constant value of the sum of the totality of the feeling values.

The basis vector, forming the space of these six basic feelings, is changed depending on for example the degree of satisfaction of the inner states, with the pleasantness (PLEASANTNESS), indicating the value of agreeableness-disagreeableness, sensor input stimuli or temporally changed inner bio-rhythm, and may be made the arousal (AROUSAL) indicating the bodily activation or certainty (CERTAINTY) indicating the degree of reliability of the results of recognition, such as individual identification.

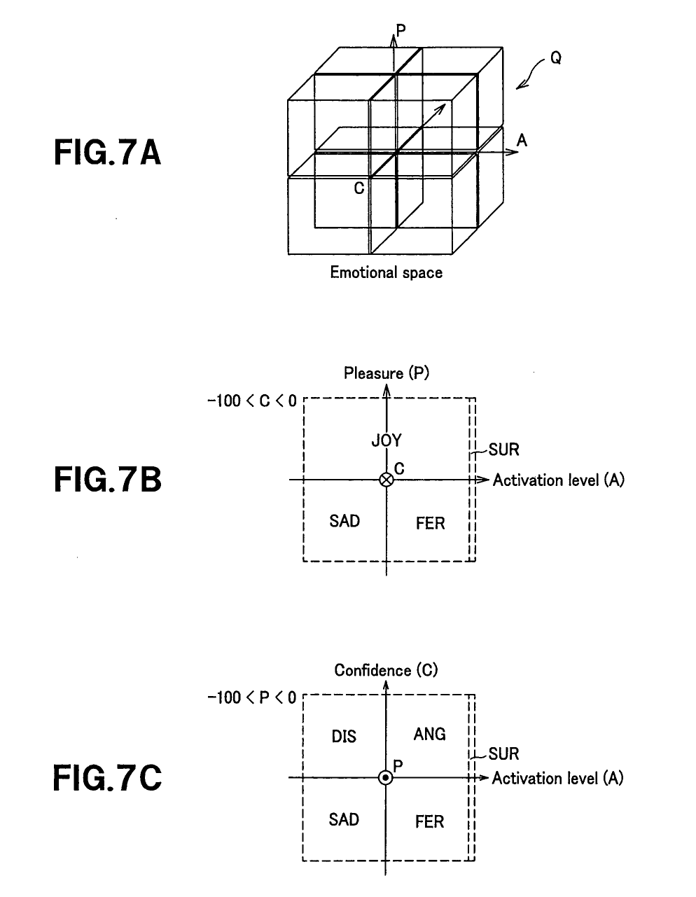

FIGS. 7a to 7c schematically show an emotional space Q representing the feeling model in the present embodiment. Referring to FIG. 7a, the emotional space Q may be represented by a three-dimensional space having the pleasantness P, activity degree A and certainty degree C. as axes. If, as shown in FIG. 7b, the certainty degree C. is such that −100<C<0, and the pleasantness P is positive, the feeling=joy (JOY). If the pleasantness P is negative and the activity degree A is negative, it indicates that the feeling=sadness (SAD) and, if the activity degree A is positive, it indicates fear (FEAR). If, as shown in FIG. 7c, the pleasantness P is such that −100<P<0, the certainty degree C. is positive, and the activity degree A is negative, it indicates that the feeling=disgust (DISGUST). If the activity degree A is positive, it indicates that the feeling is anger (ANGER). If the certainty degree C. is negative and the activity degree A is negative, it indicates that the feeling=sadness (SADNESS) and, if the activity degree A is positive, it indicates that the feeling=fear (FEAR). In any case, if the activity degree A is large, it indicates that the feeling=surprise (SURPRISE).

By exploiting the sensor information owned by the robot apparatus itself, insofar as the robot apparatus itself is concerned, the above-mentioned inner states or feeling states may be calculated directly from the actual body states by the self inner state management unit 91 or by the self emotion value calculating unit 94.

(3) Method for Managing the State of the Counterpart

On the other hand, the inner state or the feeling state of the counterpart cannot be directly known, and hence the state of the counterpart needs to be inferred by observing the counterpart and inferring the state of the counterpart by exploiting the information perceivable using a sensor.

For this reason, there is provided a model of the counterpart for supervising the inferred inner or feeling states of the counterpart within the robot apparatus itself. The model of the counterpart comprises plural parameters, similar to the inner and feeling states of the robot apparatus itself, and which have been set for the counterpart. The values of these parameters are supervised in the counterpart inner state management unit 96 and the counterpart emotion management unit 97 of the counterpart state management unit 98.

First, the method for inferring the inner state of the counterpart by the counterpart inner state management unit 96 is explained. For example, as a method for inferring the extent of the fatigue or drowsiness of the counterpart, the inner state of the counterpart may be inferred from the vigor of gesture or expression of the counterpart, with the aid of the picture processing technique. The inner state of the counterpart may also be inferred from the state of the sampled voice of the counterpart, with the aid of the speech processing technique. The simplest method is to have a dialog with the human being, as a subject of inference, whose state is to be inferred, in order to acquire the information concerning the inner state of the counterpart through such dialog.

As for the state of undernourishment or excessive nourishment of the counterpart, such counterpart may directly be asked whether he/she is hungry. Or, the counterpart may be asked when he/she took breakfast for making an inference. As for the degree of fatigue of the counterpart, he/she may directly be asked when he/she had exercise, or when he/she went upstairs. At any rate, it is possible to embed a query for acquiring the state of the counterpart in a sequence of a dialog story, from the outset, or to hold a keyword for estimating the inner state of the counterpart in a database and to monitor the words recognized by the dialog with the counterpart in order to reflect it in the inner state of the counterpart. Referring to these methods for inferring the inner state of the counterpart, the method described above is merely illustrative, it being only sufficient to use a suitable technique to infer the inner state of the counterpart to render the result inferred in numerical representation.

As for the method for inferring the feeling state of the counterpart by the counterpart emotion management unit 97, the feeling of the counterpart can be recognized by the method for recognizing the expressions of the counterpart, method for recognizing the voice of the counterpart, or by the combination of the two. The technique for recognizing the feeling of the counterpart is stated in, for example, the Patent Nos.2874858, 2967058 and 2960029 and in the Japanese Laid-open Patent Publication 2002-73634. In these methods for feeling recognition, a dedicated sub-recognition unit is provided for each feeling, and outputs of these sub-recognition units are logically combined to give an ultimate output, or the results of recognition based on plural characteristic values are differentially weighted and combined together to give an ultimate output. In case of using weighting parameters, integrating the results of recognition, calculations may be made on the basis of tentatively sampled teacher data, or parameters used by each recognition unit may be prepared for each person being recognized.

As for specified methods for recognizing the feeling of the counterpart, in case of analyzing the facial expressions, the results of filtering processing of extracting the frequency components or direction components of the entire picture are extracted as characteristic values, and the feeling of the counterpart may then be inferred based on these characteristic values. Alternatively, e.g. vector data, numerically representing the features of elements, visually represented on the face of the counterpart, such as forehead, eyebrows, density or orientation of wrinkles on the cheek, degree of eye opening or lip shape, may be extracted as characteristic values, based on which the feeling of the counterpart may be inferred. In analyzing the gesture, the amount of movement or the movement speed of the hand chip position, or the frequency of turning of the hand chip trajectory, may be extracted as characteristic values, based on which the feeling of the counterpart may be inferred. In analyzing the speech, uttered by the counterpart, the average sound pressure (power), fundamental frequency (frequency with which a pattern of repetition of similar waves appears) and spectral data, for example, are extracted as characteristic values, based on which the feeling of the counterpart may be inferred.

The feeling on the part of the counterpart may also be inferred from words uttered by the counterpart by inserting, in a dialog sequence, a phrase inquiring into the feeling on the part of the counterpart. As for the method for inferring the feeling on the part of the counterpart, the sum is to use any suitable method for recognition of the feeling of the counterpart, and the above-mentioned methods are not intended to limit the invention.

(4) Technique for Behavior Selection for Satisfying the Self Inner State

A plural number of schemas 132, making up the SBL 102, are modules determining behavior outputs from the self inner states, the inner states of the counterpart and from the external stimuli. A state machine is provided for each module, and the results of recognition of the external information, input via sensors, are classified, in dependence upon the temporally previous behaviors (behaviors), to demonstrate the behavior on the main body unit of the robot apparatus. This module (behavior describing module) is stated as a schema having the monitor function of giving a decision on the situation in dependence upon the external stimuli and upon the self inner states and on the inner states of the counterpart to calculate the activation level AL, and a behavior function for realization of the state transition attendant on behavior execution (state machine). In each schema 132, there are defined preset self inner states, inner states of the counterpart and the external stimuli, conforming to the component behaviors described therein.

The external stimuli means perception information of the robot apparatus, recognized by the recognition unit 80, and may be enumerated by, for example, the subject information, such as color information, shape information or facial information, processed from a picture input from e.g. a camera. Specified examples of the external stimuli include color, shape, face, routine 3D objects, hand gestures, movements, voice, contact, distance, place, time and the number of times of interactions with the user.

For example, if the ALself is to be calculated in the schema 132 of an component behavior, having ‘eating’ as a behavior output, the sort of the object (OBJECT_ID), the object size (OBJECT_SIZE) and the distance to the object (OBJECT_DISTANCE) are handled as the external stimuli, whilst ‘NOURISHMENT’ (state of nourishment) and ‘FATIGUE’ (fatigue), are handled as the self inner state. It is to be noted that a given self inner state, a given inner state of the counterpart and a given external stimulus may be associated not only with the sole component behavior, but also with plural component behaviors.

The method of calculating the ALself based on the own state from the self state management unit 95 and on the external stimuli is now explained. The self inner state management unit 91 of the self state management unit 95 is supplied with the information exemplified by the external stimuli, residual quantity of the own battery or the rotational angle of the motor to calculate and supervise the values of the self inner state s, having the aforementioned plural inner states as elements (self inner state vector IntV (Internal Variable)). For example, the self inner state (state of nourishment) is determined based on the residual quantity of the battery, while the self inner state ‘fatigue’ may be determined based on the power consumption.

The self AL calculating unit 122 of the activation level calculating unit 120 refers to the self DB 121, as later explained, to calculate the self AL for each component behavior at a time point from the self inner state and from the external stimuli at a given time point. In the present embodiment, this self AL calculating unit 122 is provided for each schema. Alternatively, the ALself may be calculated for the totality of the component behaviors by a sole self AL calculating unit.

The ALself for each component behavior is calculated from the self instinct value for each behavior, conforming to each current self inner state, the degree of satisfaction, which is based on the current self inner state, and from the anticipated change in the degree of self satisfaction, indicating the amount of change of the self inner state, anticipated to take place by external stimuli, that is, the amount of change of the self inner state anticipated to take place as a result of inputting of the external stimuli and ensuing behavior demonstration.

Here, such an example is explained, in which, as a specified example of calculating the ALself, an object of a certain ‘sort’ and ‘size’ is at a certain ‘distance’, the activation level AL of a schema, the behavior output of which is ‘eating’, is calculated from the ‘state of nourishment’ and ‘fatigue’ as self inner states.

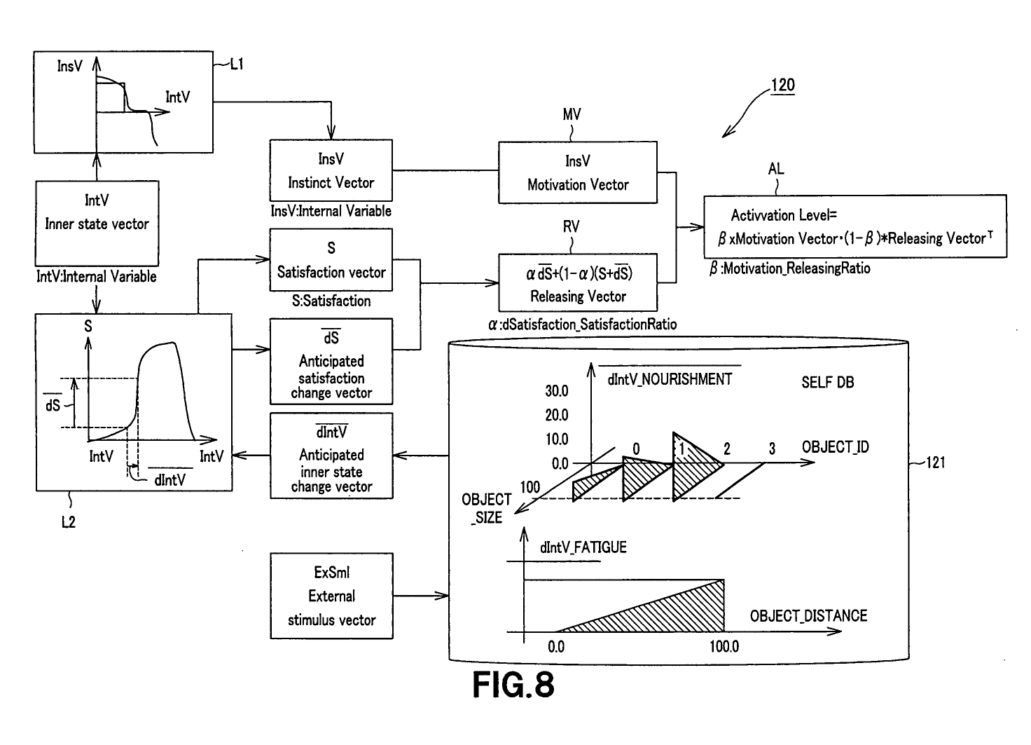

FIG. 8 schematically shows the processing flow for the self AL calculating unit 122 of the activation level calculating unit 120 to calculate the activation level AL from the self inner state and from the external stimuli. In the present embodiment, the self inner state vector IntV (internal variable), having one or more self inner state as a component, is defined for each component behavior, and the inner state vector IntV conforming to each component behavior is obtained from the self inner state management unit 91. That is, each component of the self inner state vector IntV indicates the value of a sole self inner state (self inner state parameter) and each component of the self inner state vector IntV is used for calculating the activation level of the component behavior. For example, for the schema having the behavior output ‘eating’, the self inner state vector IntV {IntV_NOURISHMENT (state of nourishment), Int_Fatigue (fatigue)'} is defined.

For each self inner state, an external stimulus vector ExStml (external stimulus) having one or more external stimuli is defined. From the recognition unit 80, the external stimulus vector ExStml, conforming to reach inner state, that is, each component behavior, is obtained from the recognition unit 80. The respective components of the external stimulus vector ExStml indicate the information of recognition, such as the size or sort of the object or the distance to the object, and each component of the external stimulus vector ExStml is used for computing the self inner state for which the component is defined. Specifically, the external stimulus vector ExStml {OBJECT_ID ‘sort of the object’, OBJECT_SIZE ‘size of the object’ } is defined for the self inner state IntV_NOURISHMENT, while the external stimulus vector ExStml {OBJECT_DISTANCE ‘distance to object’ } is defined for the self inner state IntV_Fatigue (fatigue).

The self AL calculating unit 122 is supplied with this self inner state vector IntV and the external stimulus vector ExStml to calculate the ALself. Specifically, the self AL calculating unit 122 includes a motivation vector calculating unit MV for finding, from the self inner state vector IntV, a motivation vector (MotivationVector) indicating how much the robot apparatus is interested in carrying out a relevant component behavior, and a releasing vector calculating unit RV for finding, from the self inner state vector IntV and from the external stimulus vector ExStml a releasing vector (ReleasingVector) and calculates the ALself from these two vectors.

(4-1) Calculation of Motivation Vector

The motivation vector, as one element for calculating the ALself, may be found from the self inner state vector IntV defined in the component behavior as self instinct value vector InsV (Instinct Variable) indicating the instinct for the component behavior. For example, the component behavior 132, having a behavior output ‘eating’ has the self inner state vector IntV {IntV_NOURISHMENT and IntV_FATIGUE} from which the self instinct value vector InsV {InsV_NOURISHMENT and InsV_FATIGUE} is found as the motivation vector. That is, the self instinct value vector InsV becomes the motivation vector for calculating the ALself.

As a method for calculating the self instinct value vector InsV, such a function may be used in which the larger the value of the self inner state vector IntV, the smaller becomes the self instinct value, with the judgment that the instinct is satisfied, and in which, when the self inner state vector IntV becomes larger than a certain value, the self instinct value becomes negative.

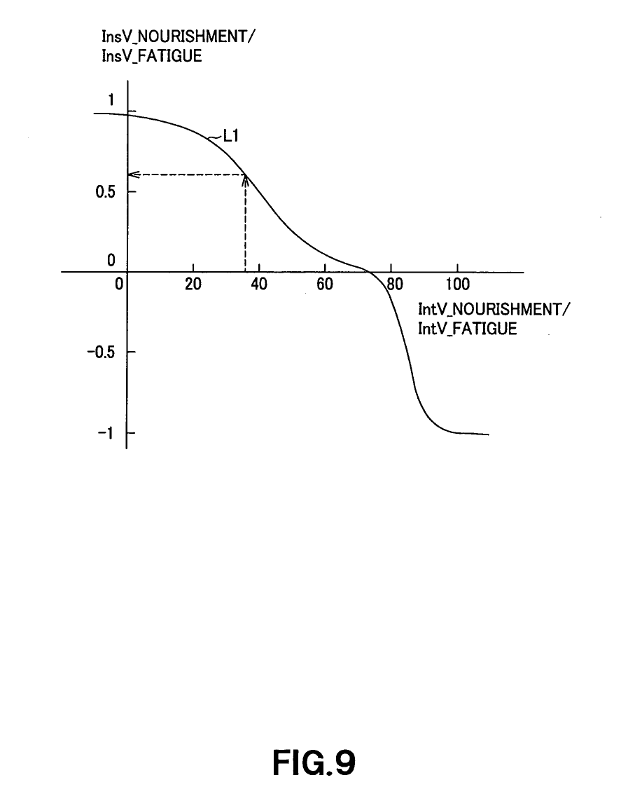

Specifically, the function represented by the following equation (1):

$$InsV = - \frac{1}{1 + exp ( - ( A \cdot IntV - B ) / C )} + \frac{1}{1 + exp ( ( D \cdot IntV - E ) / F )} \qquad ( 1 )$$

where
IntV: the self inner state vector
InsV: the self instinct value vector
A to F: constants
   , and shown in FIG. 9, may be used. FIG. 9 shows the relation between the inner state and the instinct value shown by the equation (1), in which components of the self inner state vector IntV and components of the self instinct value vector InsV are plotted on the abscissa and on the ordinate, respectively.

The self instinct value vector InsV is determined solely by the value of the self inner state vector IntV, as shown by the equation (1) and by FIG. 9. Here, such a function is shown in which the size of the self inner state is 0 to 100 and the size of the self instinct value is −1 to 1. For example, the robot apparatus is able to select the behavior so as to maintain the self inner state of 80% at all times if, when the self inner state of 80% is met, the self inner state-self instinct value curve L1 is set so as to yield the self instinct value equal to 0. This indicates that, in case the instinct corresponding to the self inner state ‘state of nourishment’ (IntV_NOURISHMENT) is the ‘appetite’ (InsV_NOURISHMENT), the appetite is increased and becomes zero when the apparatus is hungry and when the apparatus has ate only moderately, respectively. In this manner, such a behavior may be demonstrated which will exhibit such instinct state.

By varying the constants A to F in the above equation, the self instinct values, variable with the self inner states, may be found. For example, the self instinct value may be changed between 1 and 0 for the self inner states from 0 to 100. Alternatively, there may be provided a self inner state-self instinct value function, different from the above equation, may be provided for each self inner state.

(4-2) Calculation of Releasing Vector

On the other hand, the releasing vector, as the other element for calculating the ALself, may be calculated from the self satisfaction vector S (Satisfaction) found from the self inner state vector IntV, and from the anticipated self satisfaction change vector as found from the external stimulus vector ExStml.

First, the anticipated self inner state change vector, represented by the following equation (2):
d\overline{Int}V={d\overline{IntV_NOURISHMENT},d\overline{IntV_FATIGUE}} (2)
where
d\overline{IntV}: anticipated self inner state change vector
d\overline{IntV_NOURISHMENT}: anticipated change of the self inner state ‘state of nourishment’
d\overline{Int_V_FATIGUE}: anticipated change of the self inner state ‘fatigue’
   in which the anticipated self inner state change vector indicates the difference between the anticipated self inner state which may be obtained after behavior demonstration, and the current self inner state, is found from the self inner state defined in each component behavior and from the external stimulus defined in this self inner state. Meanwhile, the overbars in the equation (2) denote that the values indicated are anticipated values.

The anticipated self inner state change vector represents a change from the current self inner state vector as anticipated after behavior demonstration, and may be found by the self AL calculating unit 122 referring to the self DB 121 to which the self AL calculating unit may have reference. In the self DB 121, there is stated the correspondence between the external stimulus vector and the self inner state change vector anticipated, as anticipated after behavior demonstration. By referring to the data of the self DB 121, the self AL calculating unit 122 is able to acquire the anticipated self inner state change vector conforming to the input external stimulus vector. The anticipated self inner state change vector, stored in the self DB 121, will be explained in detail subsequently. Here, the method for finding the anticipated self inner state and the anticipated self instinct value change from the self DB 121 is first explained.

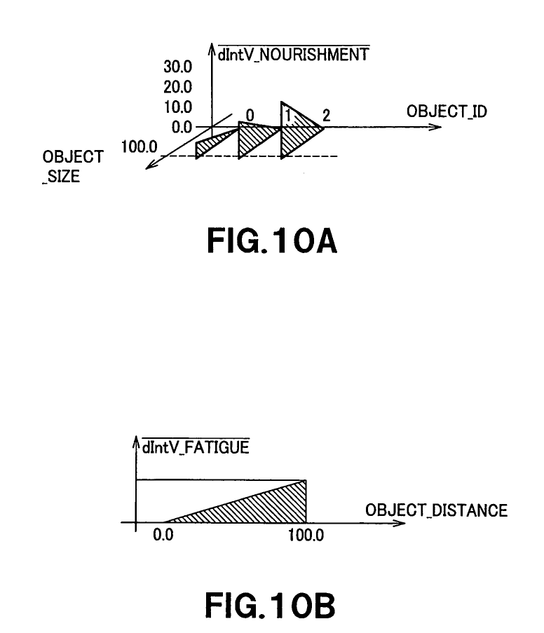

FIG. 10a shows a case in which, insofar as the self inner state ‘nourishment’ (NOURISHMENT) is concerned, as the size of the object (OBJECT_SIZE) is larger, an object M2 corresponding to the object sort (OBJECT_ID) of OBJECT_ID=1 will need a larger quantity than an object M1 corresponding to the object sort (OBJECT_ID) of OBJECT_ID=0, while an object M3 corresponding to the object sort (OBJECT_D) of OBJECT_ID=2 will need a larger quantity than the object M2 corresponding to the object sort (OBJECT_ID) of OBJECT_ID=1, as a result of demonstration of the component behavior ‘eating’.

Referring to FIG. 10b, there is shown a case in which, as regards the self inner state ‘fatigue’, the larger the distance of the object ‘OBJECT_DISTANCE’, the larger is the anticipated quantity met of the self inner state ‘FATIGUE’ and the more the robot apparatus is anticipated to be tired, as a result of demonstration of the component behavior ‘eating’.

That is, given the above-mentioned definition of the self inner state vector IntV and the external stimulus vector ExStml for each component behavior, if a vector having the object size and the object sort as components of the external stimulus vector ExStm is supplied, an anticipated self inner state change vector for the result of outputting of the component behavior associated with the self inner state vector having, as component, the self inner state IntV_NOURISHMENT (state of nourishment), for which the external stimulus vector ExStm is defined, is found and, if a vector having a distance to the object is supplied, an anticipated self inner state change vector for the result of outputting of the component behavior, for which is defined the self inner state vector, having, as component, the self inner state IntV_FATIGUE (‘fatigue’), for which the external stimulus vector ExStm is defined, is found.

Then, from the self inner state vector IntV, the self satisfaction vector S, indicated by the equation (3):
S={S_{—}NOURISHMENT,S_{—}FATIGUE} (3)
where
S: self satisfaction vector
S_NOURISHMENT: self satisfaction for the self inner state ‘state of nourishment’
S_FATIGUE: self satisfaction for the self inner state ‘fatigue’
   is calculated, and the anticipated self satisfaction change vector, shown in the equation (4):
   d\overline{S}={d\overline{S_NOURISHMENT},d\overline{S_FATIGUE}} (4)
   where
d\overline{S}: anticipated self satisfaction change vector
d\overline{S_NOURISHMENT}: anticipated change in the self satisfaction for self inner state ‘state of nourishment’
d\overline{S_FATIGUE}: anticipated change in the self satisfaction for self inner state ‘fatigue’
   is found from the anticipated self inner state change vector, shown by the above equation (2).

As a method for calculating the self satisfaction vector S for the self inner state vector intV, the functions indicated by the following equations (5-1) and (5-2):

$$\begin{matrix}\begin{matrix}\begin{matrix}Satisfaction \\ ( S\_NOURISHMENT )\end{matrix} = - 1 + \frac{1}{1 + exp ( - ( A \cdot IntV - B ) / C )} + \\ \frac{1}{1 + exp ( ( D \cdot IntV - E ) / F )}\end{matrix} & ( 5 \text{-} 1 ) \\ \begin{matrix}\begin{matrix}Satisfaction \\ ( S\_FATIGUE )\end{matrix} = 1 - \frac{1}{1 + exp ( - ( A \cdot IntV - B ) / C )} - \\ \frac{1}{1 + exp ( ( D \cdot IntV - E ) / F )}\end{matrix} & ( 5 \text{-} 2 )\end{matrix}$$

where
A to F: constants
   may be used for the components IntV_NOURISHMENT (state of nourishment) and IntV_FATIGUE (fatigue) of the self inner state vector {IntV_NOURISHMENT, IntV_FATIGUE} defined in the component behavior.

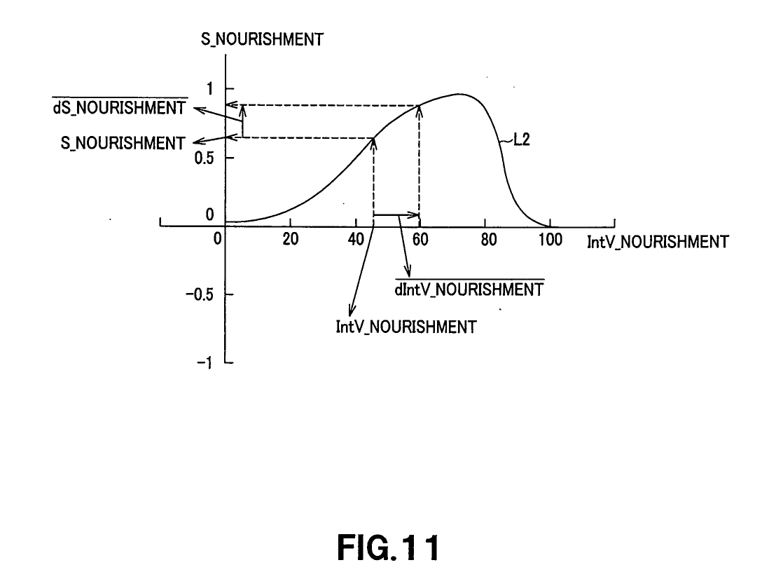

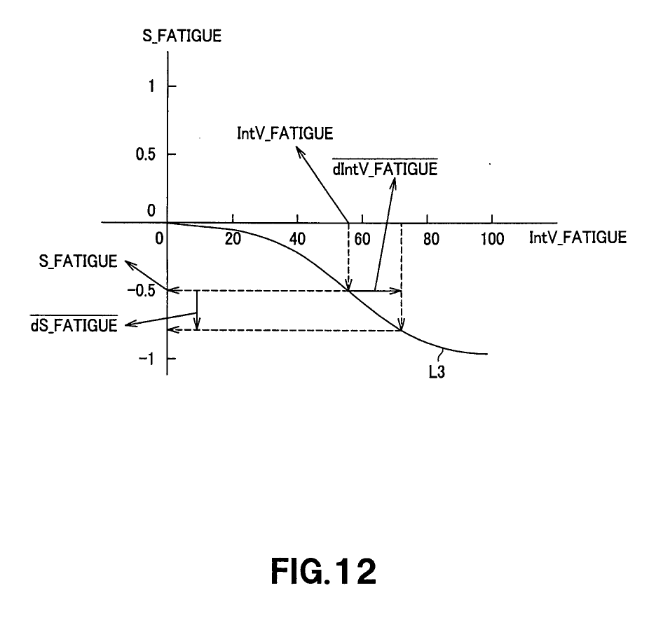

FIGS. 11 and 12 are graphs showing the functions represented by the above equations (5-1) and (5-2), respectively. Specifically, FIG. 11 is a graph showing the relation between the self inner state and self satisfaction, in which the self inner state IntV_NOURISHMENT (state of nourishment) is plotted on the abscissa and the self satisfaction vector S for the self inner state (state of nourishment) is plotted on the ordinate, and FIG. 12 is a graph showing the relation between the self inner state and self satisfaction, in which the self inner state IntV_FATIGUE (state of nourishment) is plotted on the abscissa and the self satisfaction vector S_FATIGUE for the self inner state (fatigue) is plotted on the ordinate.

The function shown in FIG. 11 is a function of a curve L2 in which the value IntV_NOURISHMENT of the self inner state (state of nourishment) has a value between 0 and 100 and the corresponding self satisfaction S_NOURISHMENT has positive values from 0 to 1, and in which the self satisfaction increases from 0 for the values of the self inner state to approximately 80, then decreases and again becomes equal to 0 for the value of the self inner state equal to 100. That is, as regards the self inner state (state of nourishment), both the self satisfaction S_NOURISHMENT, calculated from the current value (ar a certain time) of the self inner state ‘state of nourishment’ (IntV_NOURISHMENT=4.0) and the anticipated change of self satisfaction corresponding to the anticipated change of the self inner state of the self inner state ‘state of nourishment’ obtained from FIG. 10a (2.0 of from 4.0 to 6.0), are both positive.

Although FIG. 8 shows only the curve L2, the function shown in FIG. 12 may also be used as the relation between the inner state and the satisfaction. That is, the function shown in FIG. 12 is a function showing a curve L3 in which the value IntV_FATIGUE of the self inner state ‘fatigue’ has a value form 0 to 100, the self satisfaction corresponding thereto has all negative values from 0 to −1 and in which the larger the self inner state, the smaller becomes the self satisfaction. The self satisfaction S_FATIGUE, calculated from the value of the current self inner state ‘fatigue’, is negative and, if the anticipated change in the self inner state of the self inner state ‘fatigue’ obtained from FIG. 10b is positive, the anticipated change vector of the self satisfaction is negative.

By variably setting the constants A to F in the functions of the equations (5-1) and (5-2), it is possible to set a function for obtaining different values of self satisfaction in association with various self inner states. The constants A to F and the constants in the equation (1) are also set in the self DB 121 from one self inner state to another. The self AL calculating unit 122 converts the self inner state to self satisfaction and to self instinct values, with the use of these constants stored in the self DB 121. The ego-parameter calculating unit 99, explained later on, refers to the self DB 121 for employing the self satisfaction and self instinct values. Or, the ego-parameter calculating unit 99 may be supplied with the self satisfaction and the self instinct values, re-calculated from the self inner state by the self AL calculating unit 122.

The value representing to which extent the self inner state is to be satisfied after behavior demonstration by the external stimulus may be determined by the equation (6):
ReleasingVector=α·d\overline{S}+(1−α)(S+d\overline{S}) (6)
where
α: d\overline{S}/S ratio
d\overline{S}: anticipated self satisfaction change vector
S+d\overline{S}: anticipated self satisfaction vector
   to find the releasing vector as the other element for calculating the ALself.

If α₁ in the equation (6) is large, the releasing vector depends strongly on the change in the anticipated change in the self satisfaction, that is, on a value indicating which self satisfaction is obtained, or by which value the self satisfaction is increased, as a result of the behavior demonstration. If conversely the value of α₁ is small, the releasing vector depends strongly on the anticipated self satisfaction, that is, on a value indicating which is the value of self satisfaction on behavior demonstration.

(4-3) Calculation of ALself

From the motivation vector, found as described above, and from the releasing vector, found as described above, the self AL may ultimately be found by the equation (7):
ActivationLevel=βMotivationVector·(1−β)ReleasingVector^{T} (7)
where
β: Motivation/Releasing ratio

If β₁ is large or small, the self AL tends to depend strongly on the self inner state (instinct) and on the external stimulus (anticipated change in self satisfaction and anticipated self satisfaction). It is possible in this manner to calculate the instinct, self satisfaction and anticipated self satisfaction from the value of the self inner state (inner state vector IntV) and from the value of the external stimulus (external stimulus vector ExStm) to calculate the self AL based on the instinct, self satisfaction and anticipated self satisfaction.

(4-4) Self DB

The structure of data stored in the self DB 121 and the method for referring to the database (method of finding the anticipated change in the self inner state) are hereinafter explained. In the self DB 121, there are stored data for finding the anticipated self inner state change vector against an input external stimulus, and representative points (values of the external stimulus) are defined on the external stimulus vector space. The anticipated change in the self inner state, indicating the anticipated change in the self inner state, is defined on the representative points. In case the input external stimulus is of a value on a representative point on the defined external stimulus vector space, the anticipated change in the self inner state is of a value defined on the representative point.

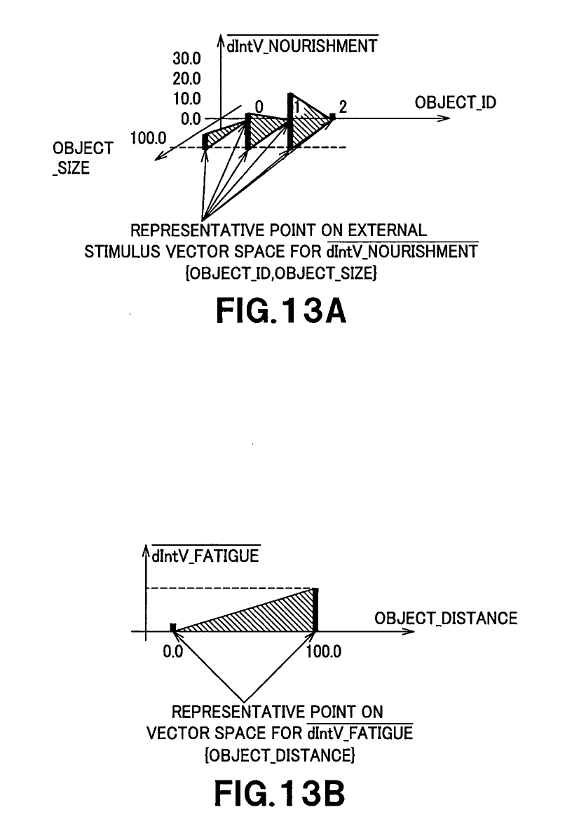

FIGS. 13a and 13b are charts showing an example of a data structure for calculating the activation level. Referring to FIG. 13a, in the anticipated change in the self inner state of the self inner state ‘state of nourishment) (‘NOURISHMENT’), representative points {OBJECT_ID and OBJECT_SIZE} on the external stimulus vector space and the anticipated change in the self inner state are defined as shown for example in Table 1:

TABLE 1

| External stimulus vector | Anticipated Change in self inner state |
|---|---|
| {OBJECT_ID, OBJECT_SIZE} | \overline{IntV _NOURISHMENT} |
| {0, 0.0} | 0.0 |
| {0, 100.0} | 10.0 |
| {1, 0.0} | 0.0 |
| {1, 100.0} | 20.0 |
| {2, 0.0} | 0.0 |
| {2, 100.0} | 30.0 |

If, as shown in FIG. 13b, the anticipated self inner state change vector of the self inner state ‘fatigue’ (‘FATIGUE’) is to be found, a representative point on the external stimulus vector space {OBJECT_DISTANCE} and the anticipated change in the inner state change associated with this representative point are defined for example as shown in the following Table 2:

TABLE 2

| External stimulus vector | Anticipated Change in self inner state |
|---|---|
| {OBJECT_ID, OBJECT_SIZE} | \overline{IntV _FATIGUE} |
| {0.0} | 0.0 |
| {100.0} | 20.0 |

Since the anticipated change in the self inner state is defined only on the representative point on the external stimulus vector space, it may be an occurrence that a value other than the representative point on the external stimulus vector space is input, depending on the sort of the external stimulus (such as, for example, OBJECT_DISTANCE or OBJECT_SIZE). In such case, the anticipated change in the self inner state is found by linear interpolation from the representative points in the vicinity of the input external stimulus.

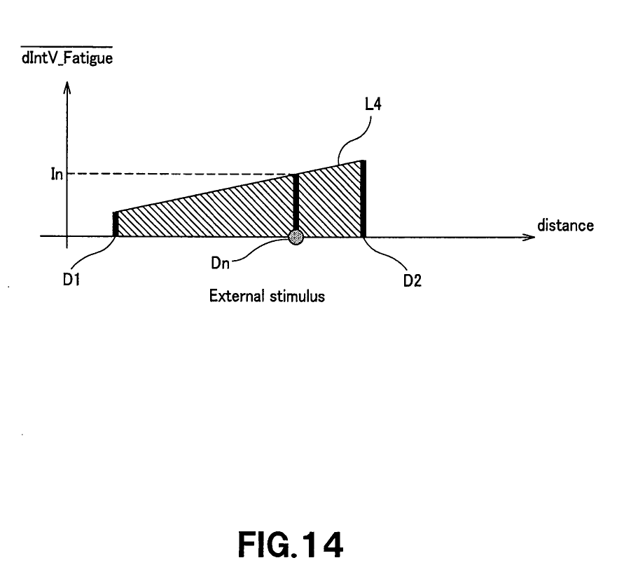

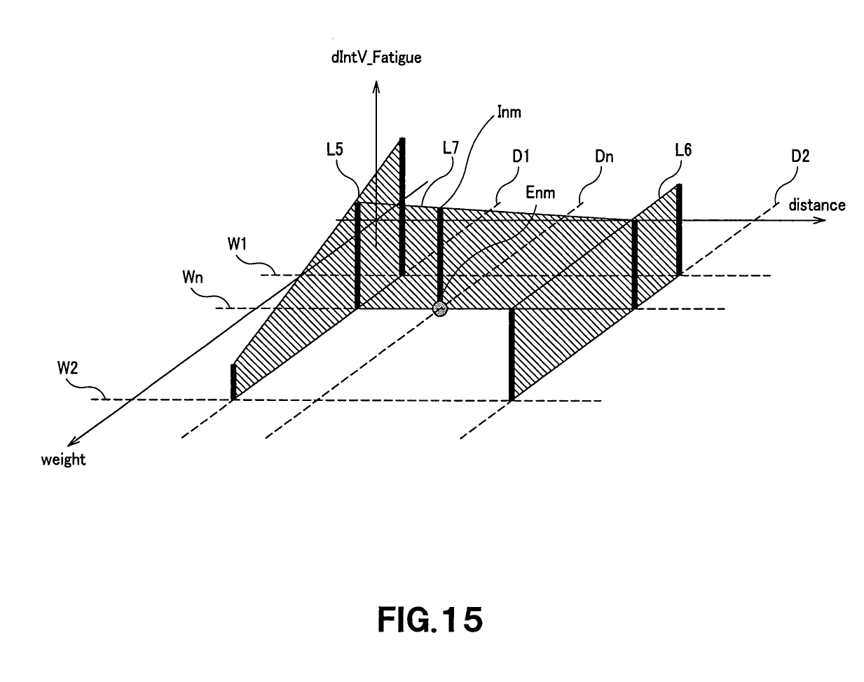

FIGS. 14 and 15 illustrate the method for linear interpolation of the one-dimensional and two-dimensional external stimuli. In case of finding the anticipated change in the self inner state from the sole external stimulus (OBJECT_DISTANCE) as shown in FIG. 13b, that is, in case a sole external stimulus has been defined in the inner state, the external stimulus is plotted on the abscissa and the anticipated change in the self inner state for this external stimulus is plotted on the ordinate. The anticipated change in the self inner state In of the input external stimulus Dn may then be found by a straight line L4 which will give the anticipated change in the self inner state as defined by the representative points D1 and D2 as parameters of the external stimulus (OBJECT_DISTANCE).

If, as shown in FIG. 15, the external stimuli, entered to the self inner state, are defined as external stimulus vector composed of two components, OBJECT_WEIGHT is defined in addition to the OBJECT_DISTANCE shown in FIG. 14, representative points (D1, W1), (D1, W2), (D2, W1) and (D2, W2) are defined as preset parameters of the external stimuli, there being corresponding anticipated change in the self inner state, and an external stimulus Enm(Dn, Wn) different from the above four representative points has been entered, a straight line L5 passing through the anticipated change in the self inner state as defined by the representative points W1, W2 of the OBJECT_WEIGHT is found for OBJECT_DISTANCE=D1, and a straight line L6 passing through the anticipated change in the self inner state as defined by the representative points W1, W2 of the OBJECT_WEIGHT is found for OBJECT_DISTANCE=D2. The anticipated change in the self inner state for the two straight lines L5 and L6 for e.g. Wn, out of two inputs of the input external stimuli Enm, is found, a straight line L7 interconnecting these two anticipated changes in the self inner state is found, and the anticipated change in the self inner state corresponding to the other external stimulus Dn of the input external stimulus in the straight line L7 is found to find the anticipated change in the self inner state corresponding to the external stimulus Enm by linear interpolation.

(4-5) Method for Finding Self AL

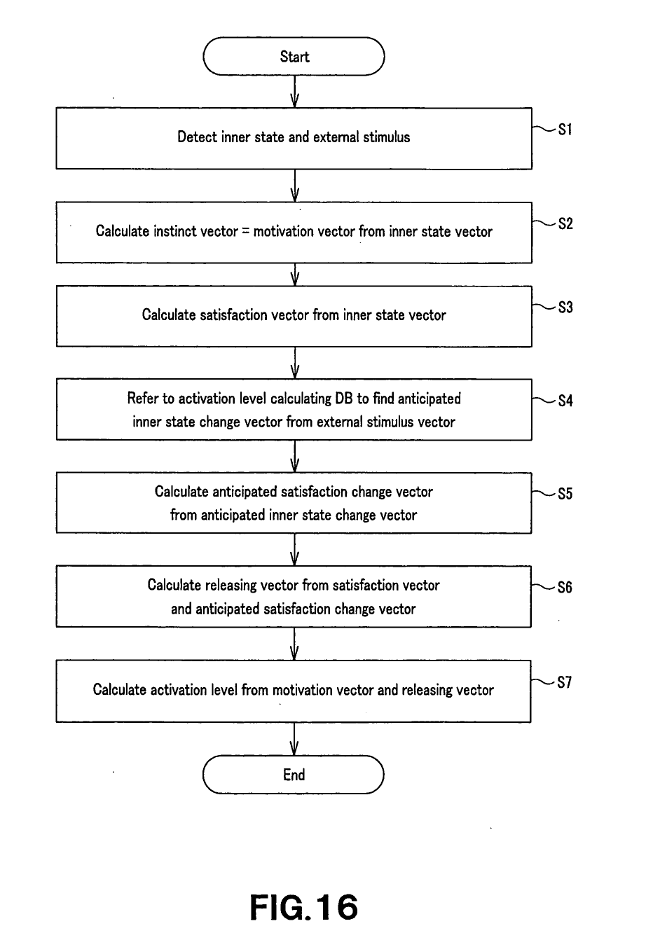

The method for calculating the activation level in a self AL calculating unit 51, shown in FIG. 5, is now explained with reference to the flowchart shown in FIG. 16.

In case an external stimulus is recognized by the recognition unit 80, shown in FIG. 4, this stimulus is sent to the activation level calculating unit 120. On notification from e.g. the recognition unit 80, each self inner state is supplied from the self state management unit 95 (step S1).

From the so supplied self inner states, corresponding self instinct values are found, using e.g. the function of the equation (1), to calculate the self instinct value vector from the self inner state vector IntV (step S2).

The self AL calculating unit 122 calculates the corresponding self satisfaction, from the respective self inner states supplied, using the functions of e.g. the equations (5-1) and (5-2), to calculate the self satisfaction vector S from the self inner state vector IntV (step S3).

From the external stimulus (external stimulus vector) supplied, the anticipated self inner state change vector, anticipated to be obtained on behavior demonstration, as described above, is found (step S4). Using a function similar to that in the step S3, the anticipated change in self satisfaction, corresponding to the anticipated change in the self inner state, is found (step S5), and a releasing vector is found from the anticipated change in self satisfaction, thus obtained, and from the self satisfaction vector, found in the step S3 (step S6).

From the motivation vector, as found in the step S2, and from the releasing vector, as found in the step S6, the self AL is calculated by the above equation (7).

In the foregoing, it is assumed that the self AL is calculated by the self AL calculating unit 122 in the steps S1 to S7 each time the external stimulus has been recognized. Alternatively, the activation level may also be found at e.g. a preset timing. When the external stimulus is recognized, and the activation level is calculated, only the self instinct value and the self satisfaction value for the self inner state pertinent to the recognized external stimulus may be calculated, or the self instinct value and the self satisfaction value for the totality of the self inner states may be calculated.

There are occasions where values other than the representative points are entered as the values of the external stimulus entered from the sensor due e.g. to noise. In such case, the anticipated change in the self inner state may be calculated by the linear interpolation method to update the anticipated change in the self inner state in the vicinity of the degree of separation from the representative point. In addition, the anticipated change in the self inner state may be found by a small processing volume.

Learning means for updating the self DB 121 may also be provided for learning the anticipated self inner state change vector from the self inner state change vector in the self DB 121.

In the present embodiment, the motivation vector and the releasing vector are found from the self inner state and the external stimuli to calculate the self AL. The self AL may, of course, be found based not only on the self inner state and the external stimuli but also on the self emotion. For example, if the feeling parameter representing the joy (JOY), out of the self emotion, is large, or if the feeling parameter representing the anger (ANGER) is large, the self AL may be enlarged or reduced, respectively.

Although the self emotion may be used for calculating the activation level AL, it may also be used for affording changes to the behavior output from the SBL 102. That is, if the feeling parameter representing the joy (JOY) is large, the robot apparatus may be caused to act quickly to appear as if the robot apparatus is invigorated, If conversely the feeling parameter representing the anger (ANGER) is large, the robot apparatus may be caused to act sluggishly to appear as if the robot apparatus does not feel like doing anything. Hence, if the activation level AL is calculated by the SBL 102 and the corresponding behavior is selected, the behavior will be demonstrated which takes the self emotion into account.

In the present embodiment, the self AL is first calculated, based on the self inner state and on the external stimulus, whereby the self AL, taking only the own state into consideration, may be acquired. The method for calculating the ALother is now explained.

(5) Technique for Selecting a Behavior Satisfying the Inner State of the Counterpart

The counterpart inner state management unit 96 in the counterpart state management unit 98, shown in FIG. 4, is supplied with the information, such as external stimuli or sensor values, and calculates the values of the inner state of the counterpart, having plural inner states of the counterpart as elements, to supervise the so calculated values. For example, the value of the inner state ‘state of nourishment’ of the counterpart may be determined by recognizing the voice ‘I'm getting hungry’ of the counterpart or by the robot apparatus directly querying the counterpart as to the time he/she took meal.

With the inner state vector of the counterpart, as with the self inner state vector, the sorts of the inner state of the counterpart and the external stimuli, handled from one component behavior to another, are defined for calculating the ALother, and the ALother for each component behavior is calculated on the basis of the values defined as above. Meanwhile, a sole self inner state, the inner state of the counterpart or the external stimuli may be associated not only with the sole component behavior but also with plural component behaviors.

That is, the ALother calculating unit 124, shown in FIG. 4, refers to a DB for the counterpart 123, and calculates the ALother in each component behavior 132 at a given time point from the external stimuli and the inner state of the counterpart at the time point.

Specifically, the ALother is calculated based on the instinct value of the counterpart for each behavior, corresponding to the current inner state of the counterpart, on the satisfaction of the counterpart for each current inner state of the counterpart, and on the anticipated change in the inner state of the counterpart, which is based in turn on the change in the inner state of the counterpart, indicating the change in the inner state of the counterpart, anticipated to take place as a result of the demonstration of the inputting of the external stimuli and behavior demonstration.

For handling the state of the counterpart, there is provided a scheme in or upstream of the counterpart state management unit 98 for modeling the state of the counterpart in the robot apparatus, and for changing the parameters in the model, based on the information obtained from the counterpart, as mentioned above. By rendering the state of the counterpart in the numerical form and supervising the state of the counterpart, it becomes possible to calculate the activation level referenced to the state of the counterpart.

The ALother is calculated, in such as manner as to take into account the inner state of the counterpart, by a process similar to that for calculating the ALself which takes the self inner state into account. The point of difference is whether the database for calculating the activation level has been set from the perspective of satisfying the self satisfaction or the counterpart satisfaction. That is, the self DB 121 is set from the perspective of getting the self satisfaction, while the DB for the counterpart 123 is set from the perspective of getting the counterpart satisfaction.

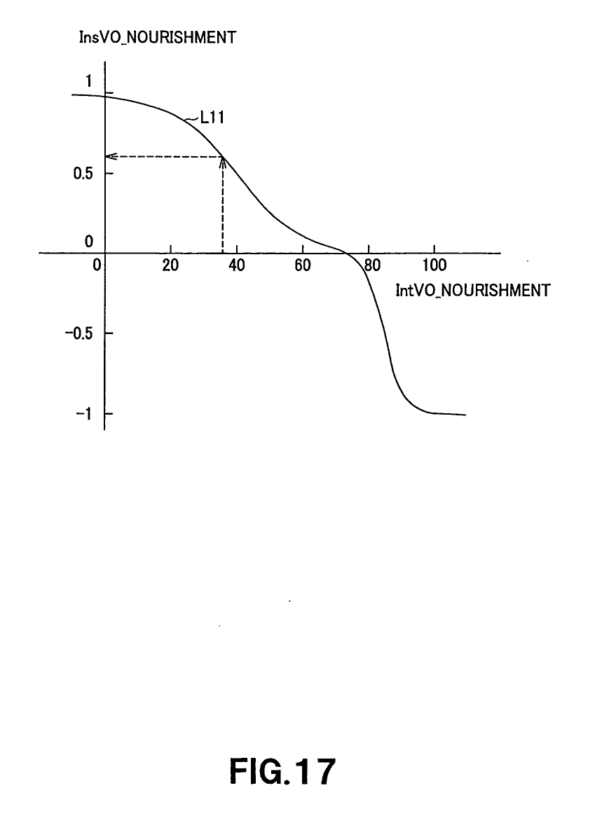

The method for calculating the ALother is now explained, taking the behavior of the robot apparatus acquiring the food and presenting it to a person (giving the food) as an example. The behavior of ‘giving the food’ is induced with the state of nourishment of the counterpart (IntV0_NOURISHMENT) as his/her inner state, as a factor. First, in a process of calculating the instinct vector of the counterpart (Instinct variable of another person) InsV0 from the inner state vector of the counterpart (internal variable of another person) IntV0, the graph (curve L11), shown in FIG. 17 and the following equation (8):

$$InsVO = - \frac{1}{1 + exp ( - ( A \cdot IntVO - B ) / C )} + \frac{1}{1 + exp ( ( D \cdot IntVO - E ) / F )} \qquad ( 8 )$$

where
IntV0: inner state vector of a counterpart
InsVO: instinct value vector of a counterpart
A to F: constants
   are used to calculate the instinct value of the counterpart.

Since the inner state of a counterpart is used as the instinct value of the counterpart satisfying his/her state, there is produced the relationship of correspondence in which the instinct value for the own behavior of ‘giving the food’ is increased when the counterpart is hungry. The instinct value of the counterpart is determined solely by the inner state of the counterpart and generally a given behavior unit may have plural inner states of the counterpart as elements. The instinct value of the counterpart, based on plural inner states of the counterpart may become an element for calculating the ALother (motivation vector), as in the case of calculating the ALself.

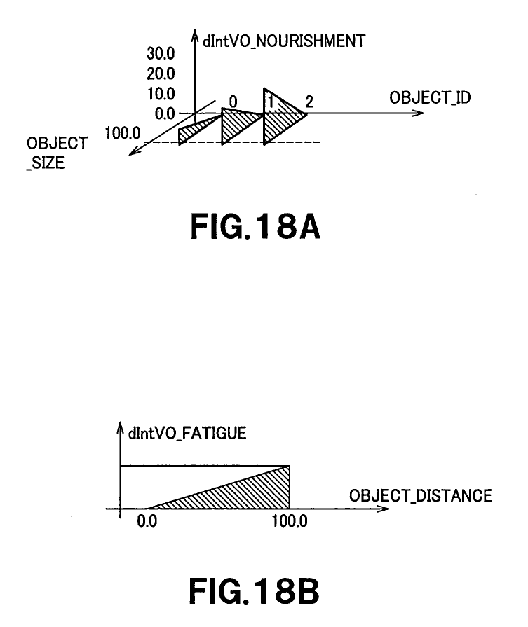

On the other hand, the anticipated change in the inner state of the counterpart may be calculated, from the external stimuli and the inner state of the counterpart, as defined in the component behavior, using data for calculating ALother, shown for example in the graph of FIG. 18. FIG. 18a shows that, in connection with the behavior of ‘presenting the food for a counterpart to eat it’, the amount of meeting the inner state of the counterpart (inner state of the counterpart) is anticipated to be larger the larger the ‘OBJECT_SIZE’ and the larger the number of the sorts of the objects ‘OBJECT_ID’ (such as 1 for 0 or 2 for 1)

FIG. 18b indicates that the larger the distance to the food ‘OBJECT_DISTANCE’, the larger is the anticipated quantity of the inner state of the counterpart (Inner state of the counterpart).

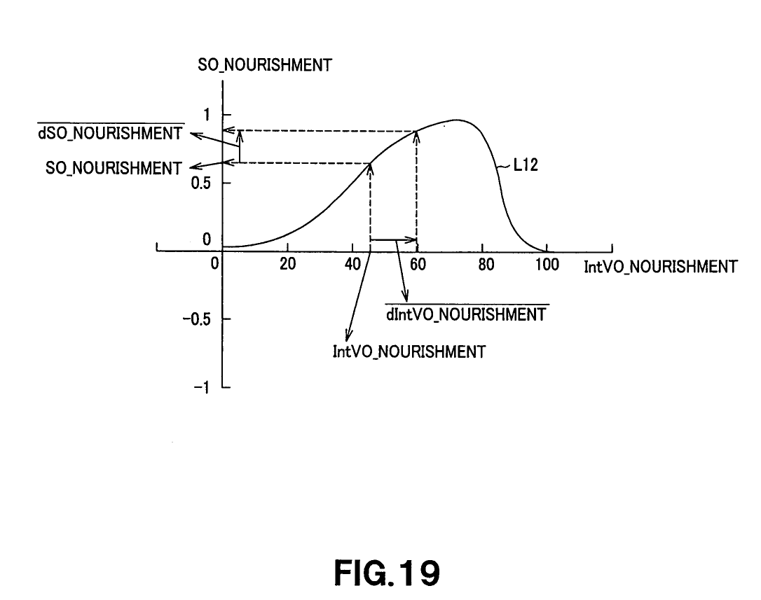

The satisfaction of the counterpart S0 is calculated from the inner state vector of the counterpart IntV0, while the anticipated satisfaction change vector of the counterpart is calculated from the inner state vector of the counterpart IntV0 and from the calculated anticipated inner state change vector of the counterpart. As the calculating method, the function shown in FIG. 19 and in the following equation (9):

$$\begin{matrix}\begin{matrix}Satisfaction \\ ( SO\_NOURISHMENT )\end{matrix} = - 1 + \frac{1}{1 + exp ( - ( A \cdot IntVO - B ) / C )} + \\ \frac{1}{1 + exp ( ( D \cdot IntVO - E ) / F )}\end{matrix} \qquad ( 9 )$$

where
A to F: constants
   may be used.

The case of FIG. 19 shows that, as regards the inner state of the counterpart ‘IntVo_NOURISHMENT’, both the satisfaction of the counterpart, calculated from the value of the inner state of the counterpart at the time point, and the anticipated change in the satisfaction as calculated from the value of the inner state of the counterpart ‘IntVo_NOURISHMENT’ and from the anticipated change in the counterpart inner state, obtained from FIG. 19, are positive.

The constants of the equations (8) and (9), that is, the parameters for determining the shape of the evaluation function for evaluating the inner state of the counterpart and for calculating the instinct value or the satisfaction of the counterpart, are saved in the counterpart DB 123 from one inner state of the counterpart to another.

A value indicating how much the external stimulus satisfies the inner state of the counterpart is determined by the following equation (10):
ReleasingVector=α₂·d\overline{S}+(1−α₂)(S+d\overline{S}) (10)
where
α₂: d\overline{S}/S ratio
d\overline{S}: anticipated satisfaction change vector of the counterpart
s+d\overline{S}: anticipated satisfaction vector of the counterpart

In general, a given behavior vector may have plural inner states of the counterpart as elements, if necessary. The satisfaction of the counterpart, based on plural inner states of the counterpart, and the anticipated satisfaction of the counterpart, become one more element ‘Releasing Vector’ for calculating the ALother.

If α₂ in the equation (6) is large, in the ALother, as in ALself, the releasing vector tends to depend strongly on the change in the anticipated change in the counterpart satisfaction, that is, on a value indicating which counterpart satisfaction is obtained. The releasing vector also tends to depend strongly on which is the increased value of the counterpart satisfaction, as a result of the behavior demonstration. If conversely the value of α₂ is small, the releasing vector depends strongly on the anticipated counterpart satisfaction, that is, on a value indicating which is the value of counterpart satisfaction on behavior demonstration.

Thus, similarly to ALself, the ALother may be calculated from the motivation vector and the releasing vector, in accordance with the following equation (11):
ActivationLevel=β₂MotivationVector·(1−β₂)ReleasingVector^{T} (11)
where
β₂: Motivation/Releasing ratio

It is noted that the larger or the smaller the value of β2, the more strongly the ALother tends to depend strongly on the counterpart inner state (counterpat instinct) and on the external stimulus (anticipated change in the counterpart satisfaction-anticipated counterpart satisfaction).

Meanwhile, α1, α2, used for finding the self releasing vector and the counterpart releasing vector, and β1, β2, used for finding the self activation level and the counterpart activation level, may be of the same value for the self and the counterpart, and may also be of different values from one behavior to another.

(6) Ego-Parameter

The ego-parameter, as a parameter for setting whether the meeting of the self state or the counterpart state is to be made much of, in selecting the self behavior, is now explained. The ego-parameter is a parameter used for weighting the self AL and the counterpart AL, found as described above, and may be set so as to be varied in dependence upon a value indicating to which extent the self state is met and to which extent the desire for behavior selection has become evident in the robot apparatus itself. The self satisfaction and the self instinct value may be re-calculated from the self inner state received from the self inner state management unit 91, by referring to the self DB 121, or may be received from the self AL calculating unit 122.

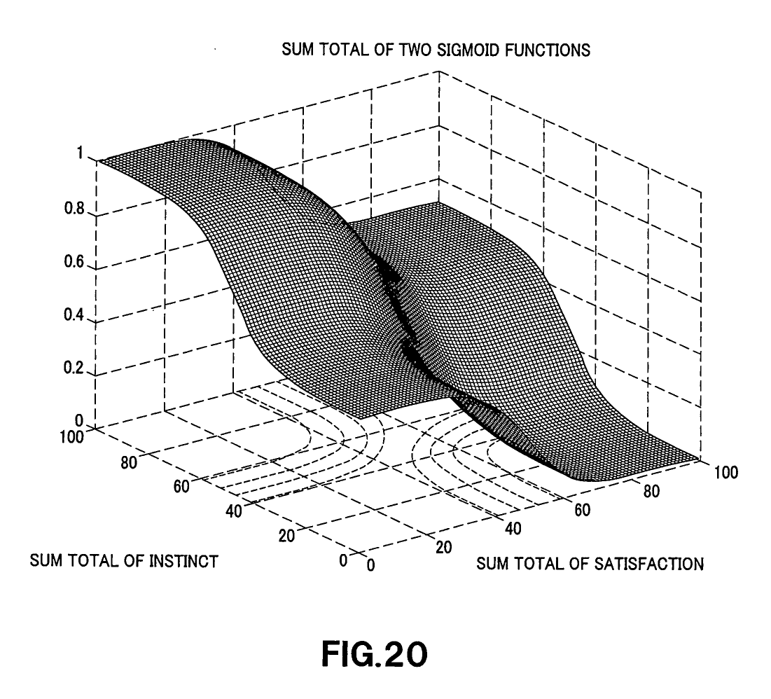

For example, the ego-parameter may be set as shown in FIG. 20 or as indicated by the following equation (12):

$$EgoisticParameter = f ( x , y ) = \frac{( \frac{1}{1 + {ⅇ}^{p ( x - {x}_{0} )}} + \frac{1}{1 + {ⅇ}^{- q ( y - {y}_{0} )}} )}{2} \qquad ( 12 )$$

where
x: sum total of self satisfaction
y: sum total of self instinct value
f: sum of two sigmoid functions
   so that, if the above two values are taken into account, the ego-parameter assumes a low value or a high value if the self satisfaction is high and the self instinct value is low or if otherwise, respectively.

In the above equation (10), the ego-parameter defines the self state as a variable. It is however possible to take positive behavior decision to make much of the counterpart, depending on the counterpart state, by taking into account the feeling of the counterpart or the counterpart inner state. If, based on the value of the counterpart inner state, as presumed from the sensor information, it is determined that the satisfaction of the counterpart inner state is low, the counterpart instinct is high, or the presumed counterpart emotion (feeling) is in a drastic state, such as extremely angry or sad, the ego-parameter is varied in a decreasing sense such as by subtracting a constant, conforming to the counterpart feeling, from the value calculated by the equation (12), to select the behavior which preferentially takes the state of the counterpart into account. Similarly to the self satisfaction or self instinct value, the counterpart satisfaction or the counterpart instinct value may be re-calculated from the counterpart inner state received from the counterpart inner state management unit 96, by referring to the counterpart DB 123, or may be received from the counterpart AL calculating unit 124. In this case, the ego-parameter may be calculated e.g. from the following equation (13):

$$\begin{matrix}EgoisticParameter = f ( x , y , u , v , w ) \\ = ( \frac{A}{1 + {ⅇ}^{p ( x - {x}_{0} )}} + \frac{B}{1 + {ⅇ}^{- q ( y - {y}_{0} )}} + \\ \frac{C}{1 + {ⅇ}^{- r ( u - {u}_{0} )}} + \frac{D}{1 + {ⅇ}^{s ( v - {v}_{0} )}} + \\ \frac{E}{1 + {ⅇ}^{- t ( w - {w}_{0} )}} )\end{matrix} \qquad ( 13 )$$

where
   A+B+C+D+E=1
x: sum total of self satisfaction
y: sum total of self instinct value
u: sum total of counterpart satisfaction
v: sum total of counterpart instinct value
w: counterpart feeling value of NEUTRAL

In the above equation (13), the third and following terms of the right side indicate the effect of the counterpart state on the ego-parameter. By adjusting the weighting parameters for the constants A to E may be adjusted so that, for normalizing the ego-parameter to a value between 0 and 1, the sum total of the coefficients of the respective terms will be equal to 1, whereby it is possible to determine in which proportions the self satisfaction, self-instinct, counterpart satisfaction, counterpart instinct and the counterpart emotion should be taken into consideration. The fifth term indicates that the value of the ego-parameter becomes larger when the counterpart feeling is in the more neutral state.

The ultimate activation level AL may be calculated in accordance with the following equation (14):
ActivationLevel=e·AL_{self}+(1−e)·ALₒₜₕₑᵣ (14)
where
ActivationLevel: activation level
e: ego-parameter
AL_{self}: activation level as calculated from the perspective of satisfying the self state (selfAL)
ALₒₜₕₑᵣ: activation level as calculated from the perspective of satisfying the counterpart state (ALother)
   in order that, if the ego-parameter is high, the behavior selection is such that emphasis is placed on the self AL, as the activation level calculated by the behavior selection standard of meeting the self state, and in order that, if the ego-parameter is low, the behavior selection is such that emphasis is placed on the counterpart AL, as the activation level calculated by the behavior selection standard of meeting the counterpart state.

In the present embodiment, described above, the activation level AL, indicating the priority of execution of the component behavior that may be taken by the robot apparatus (alternative for selection), may be calculated from the viewpoints of meeting the self state and of meeting the counterpart state. With use of the ego-parameter, there is no necessity of providing separate component behaviors for the respective viewpoints, such that the totality of the component behaviors may be handled in a unified fashion.

It is now contemplated that, in the case of a large unit of the component behavior of ‘playing soccer’, made up by small component behaviors of ‘approaching to a ball’ or ‘kicking a ball’, the large unit component behavior is to be executed from the viewpoint of the self AL. In case the self inner state of the self ‘vitality’ is large, and the instinct of ‘having exercise’ is increased, the behavior of ‘searching a ball’ is selected, based on this instinct, and behavior selection then is made, on the basis of the will decision process of ‘approaching to a ball’, with the external stimulus that, although the ball has been found, it is yet remote.

However, if the same behavior is to be executed from the perspective of the activation level of the counterpart (otherAL), the will decision process for the behavior differs from that described above. That is, if the robot apparatus has made an interactive dialog with the counterpart or has observed the expressions or gestures and it may be surmised that the counterpart is in a ‘sad’ humor and is low in ‘VITALITY’, the counterpart inner state is evaluated ‘from the perspective of cheering up the counterpart by having some performance’, and the counterpart AL of the behavior of ‘playing soccer’ is increased to select the behavior. In such case, the component behaviors divided into fine units may be changed over with the external stimulus similar to that in calculating the self AL as a factor.

By taking the weighted sum of the results of evaluation from these two viewpoints, as indicated by the equation (14), it is possible to calculate the activation level derived from the two viewpoints. If the above equation (14) is used, the ego-parameter may be calculated from the five parameters of the self satisfaction, self instinct value, counterpart inner state (counterpart satisfaction and counterpart instinct) and the counterpart emotion. By changing the weights in taking account of these parameters, or by directly applying the bias to the ego-parameter, it is possible to change the behavior selection standard of the robot apparatus to change its character. For example, if the positive bias is applied to the ego-parameter, the tendency to select the behavior based on the own standard becomes pronounced to enable ego-centered behavior selection.

In the present embodiment, the ego-parameter has been selected as being common in calculating the totality of the behavior levels. Alternatively, an ego-parameter calculating unit may be provided for each activation level calculating unit 120, and a parameter for determining whether emphasis is to be made on the self state or the counterpart state may individually be set for each schema.

In the explanation of the above equations (12) and (13), the sum total of the self satisfaction and the sum total of the self instinct value are used. It is however also possible to use specified self satisfaction and/or self instinct value out of the total self satisfaction and self instinct values.

(7) Technique of Saving Computer Resources

Meanwhile, if the activation level is calculated for the totality of the component behaviors by the above method, as the self state and the counterpart state are taken into account, that is, if this calculation is carried out simultaneously in parallel by the schemas of the so-called SBL 102, the calculation cost is extremely high. In particular, since it may be considered that the number of the component behaviors is increased with the evolution and increasing complexity of the behaviors, it may be feared that the computing speed is progressively lowered, in case limitations are imposed on the computer resources. For example, if a schema is provided which states a behavior expressing the gesture carried out when no meaningful behavior is being performed, there is a probability that all behaviors are selected, thus increasing the processing volume.

Among the methods for reducing the load of the calculations, there is a method of decimating the calculations in the SBL 102. That is, the schemas are classified, and the activation level is calculated only for those schemas likely to be booted or act as interrupt. For example, the processing volume in the SBL 102 may appreciably be diminished by not carrying out calculations of the activation level pertinent to the behavior irrelevant to the current behavior, such as dancing behavior, during soccer playing, until the ball is actually kicked or until the ball is lost sight of such that game prosecution is resigned.

Among the techniques of not computing, in a schema stating a certain component behavior, the activation level of a component behavior irrelevant to a component behavior of interest (these behaviors being in the exclusive relation to each other), there is such a technique consisting in not computing the activation level of a behavior employing the same resources as those utilized by the behavior currently executed. In this technique, several sorts of dummy resources (not meaning physical hardware resources but meaning resources used exclusively for describing the exclusive relation among the schemas) are defined and the resources used by the schemas which are in the aforementioned exclusive relation are declared to be the same resources. The resources to be used by the behaviors stated in the schemas, that is, the joints or the speech or visual sense, declared to be used, are excluded. The computing load may be decreased by not computing the behavior level of the schemas which are in the aforementioned exclusive relation with the schema of interest.

It may be an occurrence that limitations are imposed on free switching of behaviors. However, if the totality of behaviors and behavior patterns are handled equivalently without scrutinizing the content of the behavior described in the component behavior, such that the activation level is freely computed without imposing any particular limitations, not only is the processing load increased, but also the behavior is changed over at random, with the consequence that different behaviors are carried out without completing previous behaviors. Such incoherent behaviors, output in succession, are not desirable for the application of the robot apparatus, and hence it is desirable to provide suitable constraint conditions for preventing this from occurring. That is, by stating the aforementioned exclusive relation in each schema, it is possible to reduce the processing volume to save computer resources as well as to prevent the robot apparatus from performing incoherent behavior selection. Meanwhile, the activation level AL may be calculated at a preset timing. However, there are occasions in which, if the activation level AV for a behavior composed of plural operations is increased during execution of another behavior by the robot apparatus, the behavior being executed is halted and another behavior with the increased activation level is demonstrated, such that behavior consistency is lost. It is therefore possible that, during execution of a behavior, the computation of the activation level for other irrelevant behaviors be stopped until a behavior is selected and a sequence of operations has come to a close. In this case, consistency may be afforded to the behavior selection of the robot apparatus and, during behavior execution, another schema halts the calculation of the activation level to reduce the processing volume.

In the present embodiment, a behavior which meets the self state or a behavior which meets the counterpart state is selected based on an activation level AL obtained on calculating the self AL and the counterpart AL, weighting the self AL and the counterpart AL with an ego-parameter usable for determining whether emphasis is to be placed on the self state or on the counterpart state, and on summing the so weighted self AL and the counterpart AL, whereby the behavior selected may be adaptively switched depending on the self state and the counterpart state to demonstrate the behavior.

The data used for calculating the ego-parameter may be solely the self inner state and whether emphasis is to be placed on the self state or on the counterpart state may be determined with the self as the reference. Alternatively, the counterpart inner state and the counterpart emotion may be used in addition to the self inner state to determine the behavior in consideration of the counterpart state, whereby it is possible to adaptively switch between placing emphasis on the self state and placing emphasis on the counterpart state. Hence, if there is no counterpart to be taken into consideration, an autonomous behavior may be taken by behavior selection with the self as reference and, if there is a counterpart, not only the self but also the counterpart may be taken into account, depending on the self satisfaction and self instinct values, or the behavior which places emphasis on the counterpart may be selected.

Moreover, the character of the robot apparatus (ego-centered or counterpart-centered) may readily be controlled by adjusting the ego-parameter to create an egoistic character or an amenable character (character which places emphasis on the counterpart).

Additionally, with the behavior selection control system of the robot apparatus of the present embodiment, each schema calculates the activation level for the case of making much of the desire and satisfaction of the robot apparatus itself and that for the case of considering the counterpart instinct or satisfaction, so that it is unnecessary to make designing in consideration of both the counterpart instinct and the counterpart satisfaction. That is, even with the same behavior output, the self AL with the self as reference and the counterpart AL with the counterpart as reference may be calculated and integrated using the ego-parameter for weighting to determine on which emphasis is to be placed whereby a sole behavior may be selected in consideration not only of self but also of the counterpart. If the behavior is intended to satisfy one of the states, the calculating conditions for the activation level may readily be changed simply by changing the ego-parameter setting.

(8) Control System for Robot Apparatus

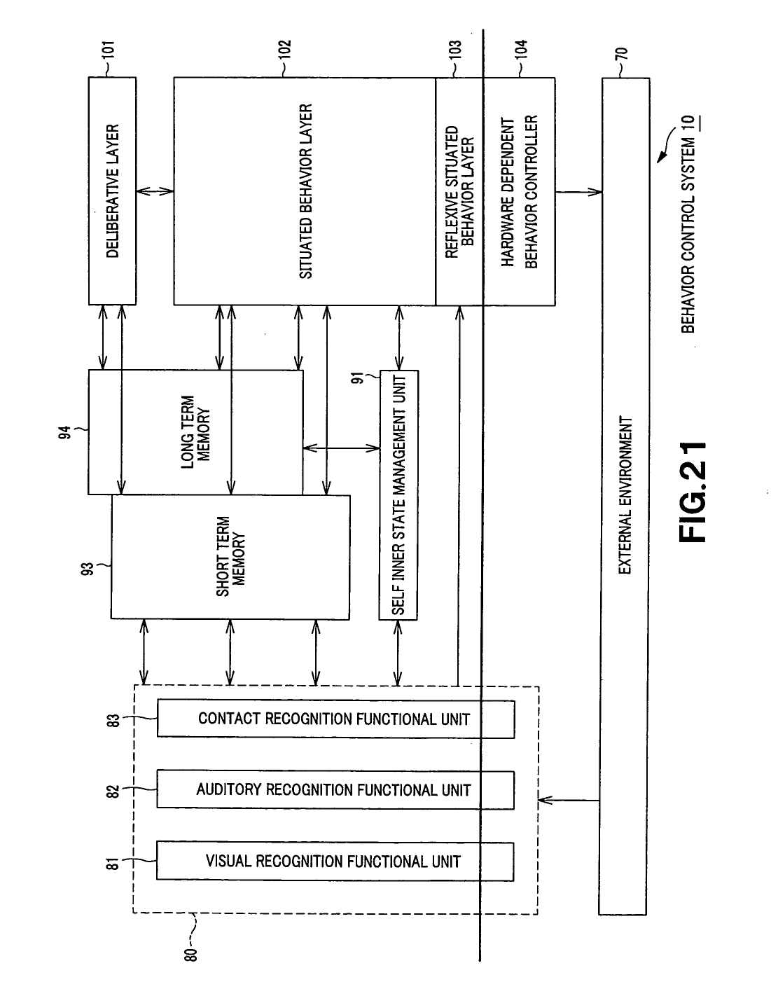

A specified example of adapting the behavior selection control system, calculating the aforementioned activation level AL to output a behavior to the control system of the robot apparatus is now explained in detail. FIG. 21 depicts the functional configuration of a control system 10 for the above-described behavior selection control system 100. The robot apparatus 1 of the present embodiment is able to exercise behavior control responsive to the result of recognition of the external stimulus and to the change in the inner state. In addition, the robot apparatus 1 includes a long term storage function and is able to perform associative storage of the change in the inner state from the external stimulus to exercise behavior control responsive to the results of recognition of the external stimuli and to changes in the inner state.

That is, the behavior selection control system calculates the activation level AL to select (generate) and demonstrate the behavior, responsive to the external stimuli, which are the color information, shape information or the face information, processed for a picture input from a camera 15 shown in FIG. 2, more specifically, color, shape, face, routine 3D objects, hand gesture, movement, voice, contact, smell, or taste, and to the inner states, specifying the emotion, such as instinct or feeling, based on the physics of the robot apparatus.

The instinctive elements of the inner state are at least one of fatigue, heat or body temperature, appetite or hunger, thirst, affection, curiosity, elimination, and sex. The emotional elements may be exemplified by happiness, sadness, anger, surprise, disgust, fear, frustration, boredom, somnolence, gregariousness, patience, tension, relaxedness, alertness, guilt, spite, loyalty, submission and jealousy.

In the control system, as illustrated, it is possible to adopt and mount an object-oriented programming. In this case, search software is handled in terms of a module termed an ‘object’ as a unit. The object is comprised of data and a processing sequence for the data, unified together. Each object is able to perform data delivery and invocation by a method for inter-object communication employing message communication and a co-owned memory.

For recognizing an external environment 70, the behavior control system 10 includes an external stimulus recognition unit 80, shown in FIG. 4, including a visual recognition functional unit 81, an auditory recognition functional unit 82 and a contact recognition functional unit 83.

The recognition functional unit (Video) 81 performs picture recognition processing, such as face recognition or color recognition, and feature recognition, based on a captured image, entered via a picture input device, such as a CCD (charge-coupled device).

The auditory recognition functional unit (Audio) 82 performs speech recognition, entered via a speech input device, such as a microphone, to extract features or to recognize a word set (text).

The contact recognition functional unit (Tactile) 83 recognizes sensor signals by a contact sensor, enclosed e.g. in a head of the main body unit, to recognize the external stimuli, such as ‘stroked’ or ‘patted’.

A state management unit (internal state manager or IMS) 91 supervises several sorts of the emotion, such as instinct or feeling, in the form of a mathematical model, and supervises the inner states, such as instinct or emotion of the robot apparatus 1, responsive to the external stimuli (ES: ExternalStimula) recognized by the visual recognition functional unit 81, auditory recognition functional unit 82 and the contact recognition functional unit 83.

The feeling model and the instinct model (feeling-instinct model) are each provided with a result of recognition and a behavior hysteresis, as inputs, and supervise the feeling values and the instinct values. The behavior model may refer to the feeling values and the instinct values.

There are also provided, for performing behavior control responsive to the results of recognition of the external stimuli or to changes in the inner state, a short term memory (STM) 92 for short-term storage which is lost as time elapses, and a long term memory (LTM) 93 for storage of the information for longer time. The classification of the storage mechanism by short-term storage and long-term storage is derived from neuropsychology.

The short term memory 92 is a functional module for holding, for a short period of time, a target or an event recognized from the external environment by the aforementioned visual recognition functional unit 81, auditory recognition functional unit 82 and by the contact recognition functional unit 83. For example, the short term memory holds an input image from e.g. the camera 15 shown in FIG. 2 for a shorter time of approximately 15 seconds.

The long term memory 93 is used for long-term storage of the information obtained on learning, such as names of objects. The long term memory 93 is able to hold changes from the external stimuli to inner states in a behavior describing module by associative storage.

The behavior control of the present robot apparatus 1 is roughly divided into a ‘reflexive behavior’ implemented by a behavior unit (reflexive situated behavior layer) 103, a ‘situation dependent behavior’ implemented by a situation-dependent behavior layer (situated behavior layer or SBL) 102, and a ‘deliberative behavior’ implemented by a deliberative behavior layer (deliberative layer) 101.

The reflexive situated behavior layer 103 is a functional unit for implementing a reflexive movement of the main body unit responsive to the external stimuli recognized by the visual recognition functional unit 81, auditory recognition functional unit 82 and the by contact recognition functional unit 83. The reflexive behavior basically depicts a behavior directly receiving the results of recognition of the external information input by sensors and classifying the received results of recognition to directly determine the output behavior. For example, the gesture of following the face of a human being or nodding is preferably mounted as a reflexive behavior.

The situated behavior layer 102 controls the behavior conforming to the situation in which is currently placed the robot apparatus 1, based on the inner states supervised by the self inner state management unit 91.

The situated behavior layer 102 is provided with a state machine from one behavior (component behavior) to another and classifies the results of recognition of the external information as input by the sensor to demonstrate the behavior on the main body unit. The situated behavior layer 102 also implements a behavior for maintaining the inner states within a preset gamut (also termed a homeostatic behavior) and, when the inner state has exceeded the designated gamut, activates the behavior of restoring the inner state to be within the gamut to facilitate its demonstration. In actuality, such behavior is selected which takes both the inner state and the external environment into account. The situation dependent behavior is slower in reaction time than the reflexive behavior. This situated behavior layer 102 is equivalent to the schema 132, activation level calculating unit 120 and to the behavior selection unit in the behavior selection control system 100, shown in FIG. 4, and calculates the activation level AL from the inner state and the external stimuli, as described above, to output the behavior accordingly.

The deliberative layer 101 carries out e.g. a behavior schedule of the robot apparatus 1 for a longer period of time, based on the stored contents of the short term memory 92 and the long term memory 93. The deliberative behavior is depicts an inference or a behavior carried out after mapping out a plan for realization of the inference. For example, the searching of a route from the position of the robot apparatus and the target position is the deliberative behavior. Since the inference or plan is likely to necessitate longer processing time or a larger computational load than the reaction time for the robot apparatus 1 to maintain the interaction, the deliberative behavior executes inference or planning as the aforementioned reflexive behavior or the situation-dependent behavior returns the reaction in real-time.

The deliberative layer 101, situated behavior layer 102 and the reflexive situated behavior layer 103 may be described as an upper application program not dependent on the hardware structure of the robot apparatus 1. Conversely, a hardware dependent layer controller 104 (configuration dependent behaviors and reactions) is responsive to commands from the upper application, that is, the behavior describing modules to directly actuate the hardware (external environment), such as joint actuators. By this configuration, the robot apparatus 1 verifies the own state and the surrounding state, based on the control program, to behave autonomously responsive to a command and a behavior from the user.

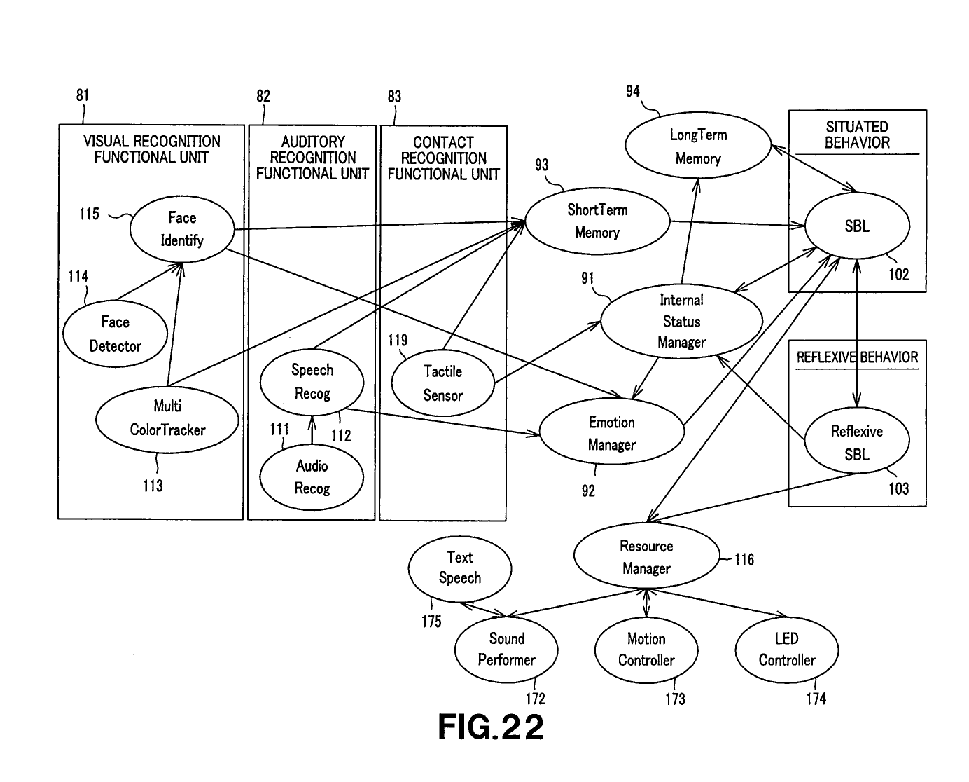

The behavior control system 10 is now explained in further detail. FIG. 22 is a schematic view showing an object configuration of the behavior control system 10 of the present embodiment.

Referring to FIG. 22, the visual recognition functional unit 81 is made up by three objects, namely a face detector 114, a multi-color tracker 113, and a face identifier 115.

A face detector 114 is an object for detecting a face area from the picture frame, and outputs the detected result to the face identifier 115. The multi-color tracker 113 is an object for color recognition and outputs the recognized results to the face identifier 115 and to the short term memory (STM) 92. The face identifier 115 identifies a person by, for example, retrieving a hand-held person dictionary for a detected face image to output the ID information to the STM 92, along with the information on the position and the size of the face image area.

The auditory recognition functional unit 82 is made up by two objects, namely an Audio Recog 111 and a Speech Recog 112. The Audio Recog 111 is an object for receiving speech data from a speech inputting device, such as a microphone, to extract the feature and to detect the speech domain. The Audio Recog outputs a characteristic value of speech data of the speech domain and the sound source direction to the Speech Recog 112 and to the STM 92. The Speech Recog 112 is an object for performing speech recognition using the characteristic speech value, a speech dictionary and a syntax dictionary, received from the Audio Recog 111, and outputs the set of the recognized words to the STM 92.

The contact recognition functional unit 83 is made up by an object called a tactile sensor 119 for recognizing the sensor input from the contact sensor, and outputs the results recognized to the self inner state management unit (ISM) 91 which is an object supervising the inner state or the feeling state (emotion).

The STM 92 is an object forming a short-term storage, and is a functional module for holding a target or an event, recognized by each object of the above recognition system from the external environment, for example, holding an input image from the camera 15 for a short period of time, such as for ca. 15 seconds. The STM periodically notifies external stimuli to the SBL 102 as an STM client.

The LTM 93 is an object forming a long-term storage, and is used for holding the information, obtained by learning, such as object name, for prolonged time. The LTM 93 is able to hold changes in the inner state from the external stimuli in a given behavior describing module (schema).

The ISM 91 is an object forming a situation-dependent behavior layer. The ISM 91 is an object which proves a client of the STM 92 (STM client) and, on receipt periodically of a notification of the information pertinent to the external stimuli (targets or events) from the STM 92, determines the schema, that is, the behavior describing module for execution, as will be explained subsequently.

The reflexive SBL (situated behavior layer) 103 is an object forming a reflexive behavior unit, and executes a reflexive direct movement of the main body unit, responsive to external stimuli recognized by each object of the above recognition system. For example, the reflexive SBL performs such behavior as following up with a human face, nodding, or avoiding an obstacle detected instantly.

The SBL 102 selects a movement responsive to external stimuli or to changes in the internal state. On the other hand, the reflexive SBL 103 selects a reflexive behavior responsive to the external stimuli. Since behavior selection by these two objects is made independently, there are occasions where computer resources compete with one another when the selected behavior describing modules (schemas) are executed on the main body unit, such that the hardware resources of the robot apparatus 1 compete with one another to render the realization of the movement unfeasible. An object termed a resource manager (RM) 116 arbitrates the hardware competition at the time of behavior selection by the SBL 102 and the reflexive SBL 103. The main body unit of the robot apparatus is actuated on notification to the objects taking part in realizing the movements of the main body unit of the robot based on the results of arbitration.

A sound performer 172, a motion controller 173 and an LED controller 174 are objects for realizing the movements of the main body unit of the robot apparatus. The sound performer 172 is an object for outputting the speech and synthesizes the speech responsive to a text command given from the SBL 102 through RM 116 to output the speech from a loudspeaker on the main body unit of the robot apparatus 1. The motion controller 173 is an object for achieving movements of the joint actuators on the main body unit of the robot apparatus and calculates relevant joint angles responsive to receipt of a command for causing movements of the arms or legs from the SBL 102 over RM 116. The LED controller 174 is an object for causing flickering of the LED 19 and carries out the flickering actuation of the LED 19 responsive to receipt of the command from the SBL 102 over RM 116.

(8-1) Situation-Dependent Behavior Control

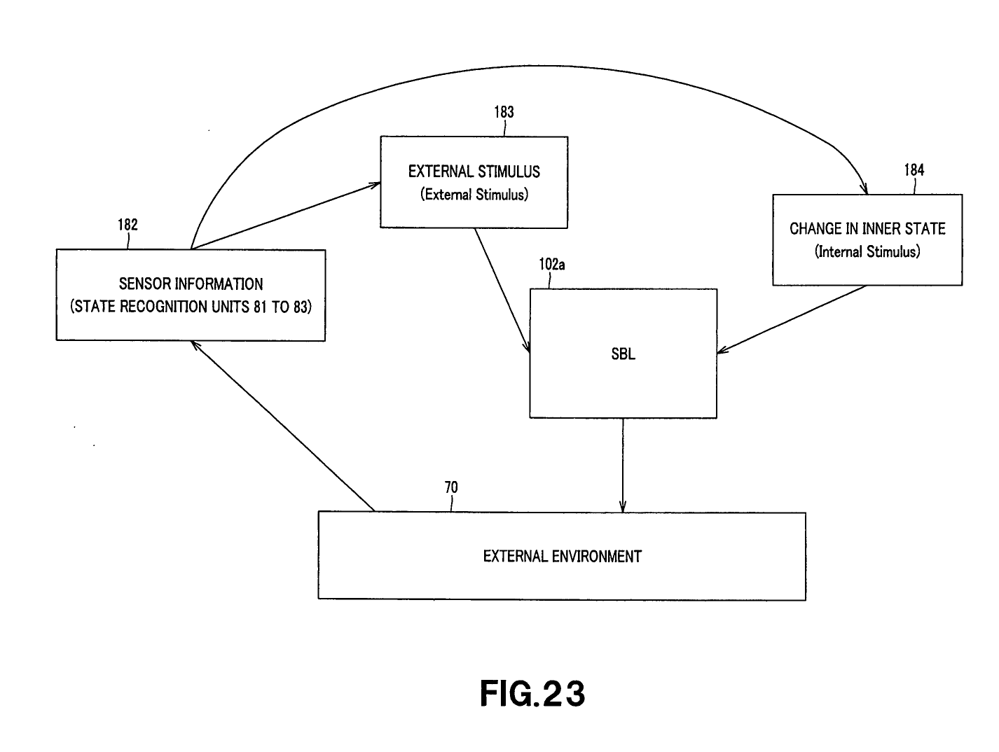

The situation-dependent behavior layer, calculating the activation level AL to select the behavior demonstrated, as explained in the above embodiments, is explained in further detail. FIG. 23 schematically shows the control configuration for the situation-dependent behavior by the situated behavior layer (SBL) inclusive of the reflexive behavior unit. Results of recognition (sensor information) 182 of the external environment 70 in the external stimulus recognition unit 80, composed of the visual recognition functional unit 81, auditory recognition functional unit 82 and the contact recognition functional unit 83, are sent as external stimuli 183 to a situated behavior layer 102a (inclusive of the reflexive situated behavior layer 103). Changes in the inner states 184, responsive to the results of recognition of the external environment 70 by the external stimulus recognition unit 80, are also sent to the situated behavior layer 102a. The situated behavior layer 102a is able to check the situation in dependence upon the external stimuli 183 or upon the changes in the inner states 184 to realize behavior selection. The activation level AL of each behavior describing module (schema) is calculated depending on external stimuli 183 or on the changes in the inner states 184 to select the schema depending on the size of the activation level AL to carry out the behavior (movement). In calculating the activation level AL, a library, for example, may be used to enable the unified computing processing to be carried out for the totality of the schemas. In the library, there are saved a function for calculating the instinct vector from the inner state vector, the function for calculating the satisfaction vector from the inner state vector and a behavior evaluating database for anticipating the anticipated inner state change vector from the external stimuli, as described above.

(8-2) Schema

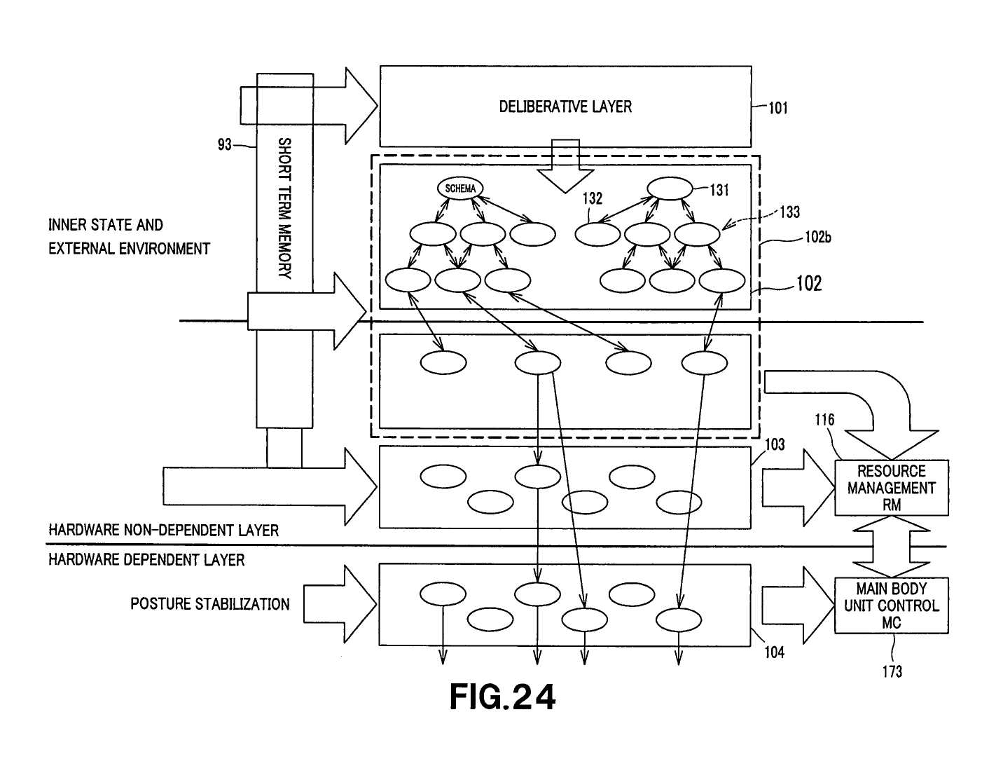

FIG. 24 shows how the situated behavior layer 102 is constructed by plural schemas 132. The situated behavior layer 102 includes a behavior describing module, as the aforementioned component behavior, and provides a state machine for each behavior describing module. The situated behavior layer classifies the results of recognition of the external information, entered via sensor, and demonstrates the behavior on the main body unit of the robot apparatus. The behavior describing module, as component behavior, is described as a schema 132 having the Monitor function of giving a judgment on the situation depending on the external stimuli or inner states and a state transition attendant on behavior execution (state machine).

A situated behavior layer 102b (more strictly, a layer in the situated behavior layer 102 controlling the usual situated behavior) is constructed as a tree structure composed of hierarchically interconnected schemas 132, and is adapted to perform behavior control as the more desirable schema 132 is comprehensively verified responsive to the changes in the inner states or external stimuli. The tree structure has a tree 131 including a behavior model comprised of an ethological situation-dependent behavior in mathematical representation and plural sub-trees or branches for demonstrating feeling expressions.

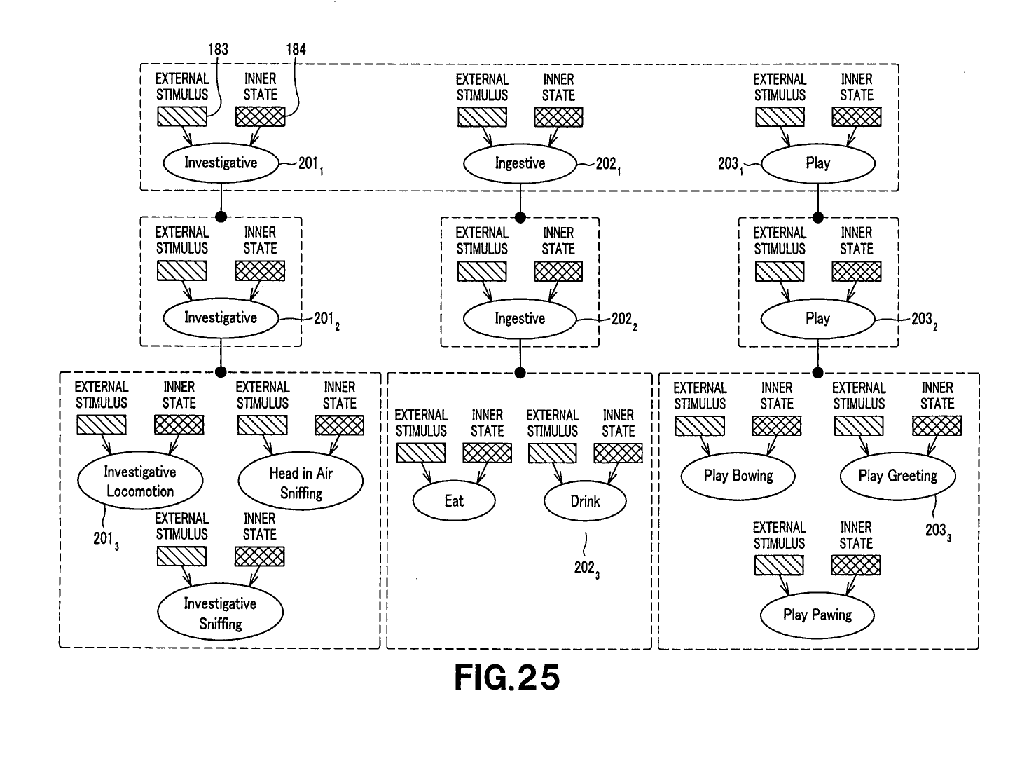

FIG. 25 schematically shows a tree structure of schemas in the situated behavior layer 102. Referring to FIG. 25, the situated behavior layer 102 includes schemas from layer to layer, from root schemas 201₁, 202₁, 203₁, receiving the notification of the external stimuli from the short term memory 92, in a direction proceeding from an abstract behavior category towards a more specified behavior category. For example, in a layer directly subjacent to the root schemas, there are arranged schemas 201₂, 202₂, 203₃, for ‘investigating’, ‘digestive’ and ‘playing’, respectively. In a lower layer of the schema 202₂, for ‘digestive’, there are arranged there are arranged plural schemas 202₃, stating more specified behaviors, such as ‘eat’ or ‘drink’. In a lower layer of the schema 203₂, for ‘playing’, there are arranged plural schemas 203₃, stating more specified behaviors, such as ‘PlayBowing’, ‘PlayGreeting’ or ‘PlayPawing’.

As shown, each schema is supplied with the external stimuli 183 and (changes in) the inner states 184. Each schema is provided with at least a Monitor function and an Action function.

The Monitor function is a function calculating the activation level AL of the schema responsive to the external stimuli 183 and to the changes in the inner states 184. Each schema has the monitor function as the activation level computing means. In constructing the tree structure shown in FIG. 25, the upper (parent) schema is able to call the Monitor function of the lower (child) schema, with the external stimuli 183 and the inner states 184 as arguments. The child schema returns the activation level AL. The schema is also able to call the Monitor function of the chilled schema in order to calculate the own activation level AL. Since the activation level AL from each sub-tree is returned to the root schema, the optimum schema dependent on the external stimuli and the changes in the inner states may be verified comprehensively. It is of course possible for a resource manager RM 116, later explained, or a behavior selection unit, provided separately, to observe the activation level AL of each schema to select the behavior based on the value of the activation level AL.

It is also possible for the behavior selection unit to select the schema having the highest activation level AL, or to select two or more schemas, the activation level AL of which has exceeded a preset threshold value, to execute the so selected schemas in parallel. It is, however, presupposed that, for such parallel operation, there is no hardware competition among respective schemas.

The Action function includes a state machine describing the behavior owned by the schema itself. In constructing the tree structure shown in FIG. 25, the parent schema may call the action function to start or interrupt execution of the child schema. In the present embodiment, the state machine of the action is not initialized unless it is Ready. In other words, the state is not reset even on interruption and work data being executed by the schema is saved, so that re-execution on interruption is possible.

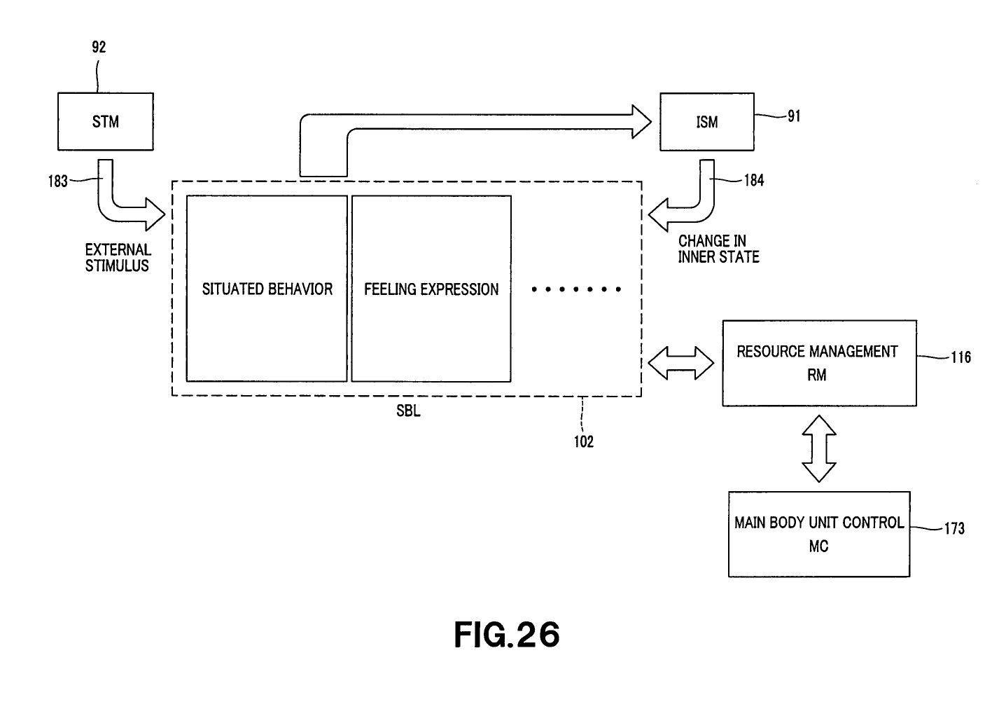

FIG. 26 schematically shows the mechanism for controlling the usual situation-dependent behavior by the situated behavior layer 102.

As shown in FIG. 26, the external stimuli 183 from the short term memory (STM) 92 and the changes in the inner states 184 from the self inner state management unit 91 are supplied to the situated behavior layer (STM) 102. The situated behavior layer 102 is formed by a behavior model, as mathematical representation of the ethological situation-dependent behavior, and a plural number of sub-trees, such as sub-tree for executing the feeling expressions. The root schema calls the monitor function of each sub-tree, responsive to a notification of the external stimuli 183, and refers to the activation level AL, as a return value thereof, to make comprehensive behavior selection, while calling the Action function to a sub-tree configured for implementing the selected behavior. The situation-dependent behavior, determined by the situated behavior layer 102, is applied to the motion controller through hardware resource arbitration by the resource manager RM 116 with the reflexive behavior by the reflexive situated behavior layer 103.

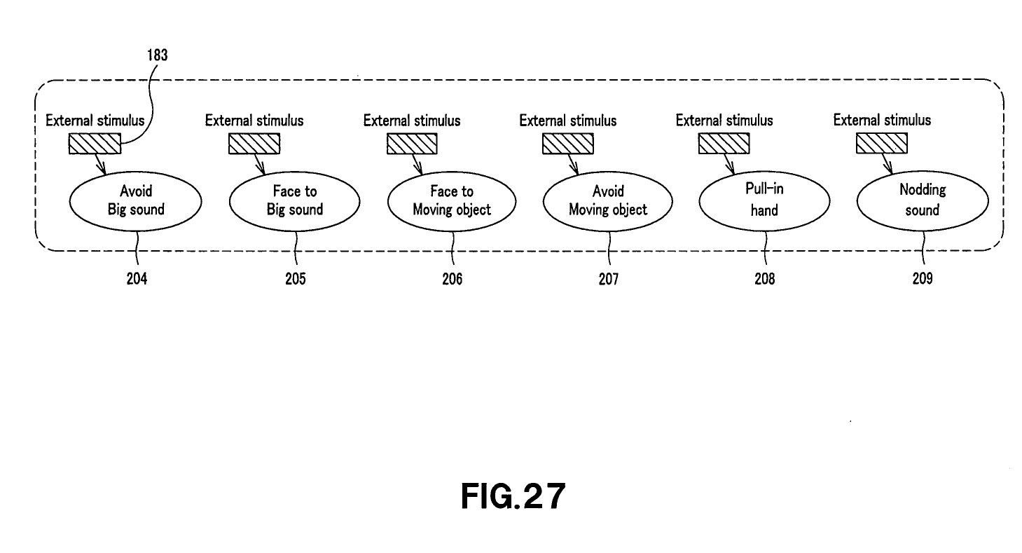

The reflexive situated behavior layer 103 executes reflexive direct movement of the main body unit, responsive to the external stimuli 183 recognized by each object of the above recognition system, such as by instantly avoiding the obstacle detected. Thus, in distinction from the usual case of controlling the situation-dependent behavior, shown in FIG. 25, the plural schemas 133, directly supplied with signals of the respective objects of the recognition system, are not layered, but are arranged in parallel, as shown in FIG. 24. As shown in FIG. 27, there are arranged in the reflexive situated behavior layer 103, in equivalent positions, that is, in parallel configuration, an Avoid Big Sound 204, a Face to Gig Sound 205, and a Nodding Sound 209, as schemas operating responsive to the results of recognition of the auditory system, a Face to Moving Object 206 and an Avoid Moving Object 207, as schemas operating responsive to the results of recognition of the visual system, and a Pull-in Hand 208, as a schema operating responsive to the results of recognition of the tactile system.

As shown, each schema, carrying out a reflexive behavior, has the external stimuli 183, as inputs. Each schema has at least a Monitor function and an Action function. The Monitor function calculates the activation level AL of the schema of interest, responsive to the external stimuli 183, to verify whether or not the relevant reflexive action is to be demonstrated. The Action function includes a state machine, stating the reflexive behavior owned by the schema itself, as later explained. When called, the Action function demonstrates the relevant reflexive behavior, while causing transition of the state of the Action.

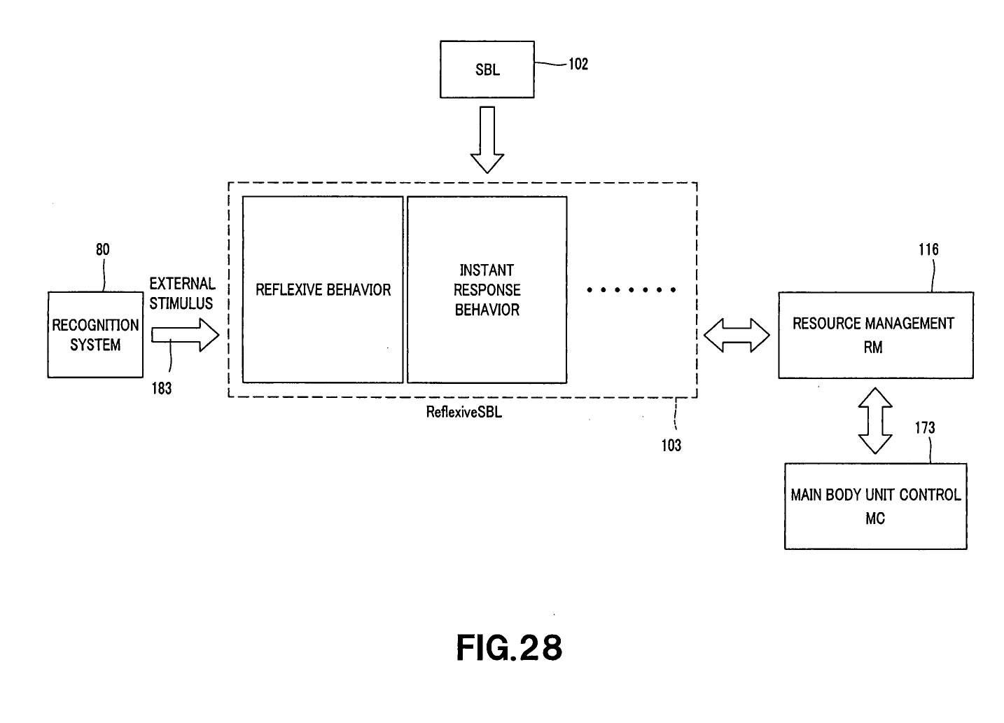

FIG. 28 schematically shows the mechanism for controlling the reflexive behavior in the reflexive situated behavior layer 103. As also shown in FIG. 27, schemas stating the reflexive behaviors and schemas stating the instant responsive behaviors are arranged in parallel configuration in the reflexive situated behavior layer 103. When the reflexive situated behavior layer 103 is supplied with the results of recognition from the objects making up the functional module 80 of the recognition system, the competent reflexive behavior schema calculates the activation level AL by the Monitor function and, based on the so calculated value, determines whether or not the Action is to be booted. The reflexive behavior, determined to be booted by the reflexive situated behavior layer 103, is applied to the motion controller 173 through hardware resource arbitration by the resource manager RM 116 with the reflexive behavior by the reflexive situated behavior layer 103.

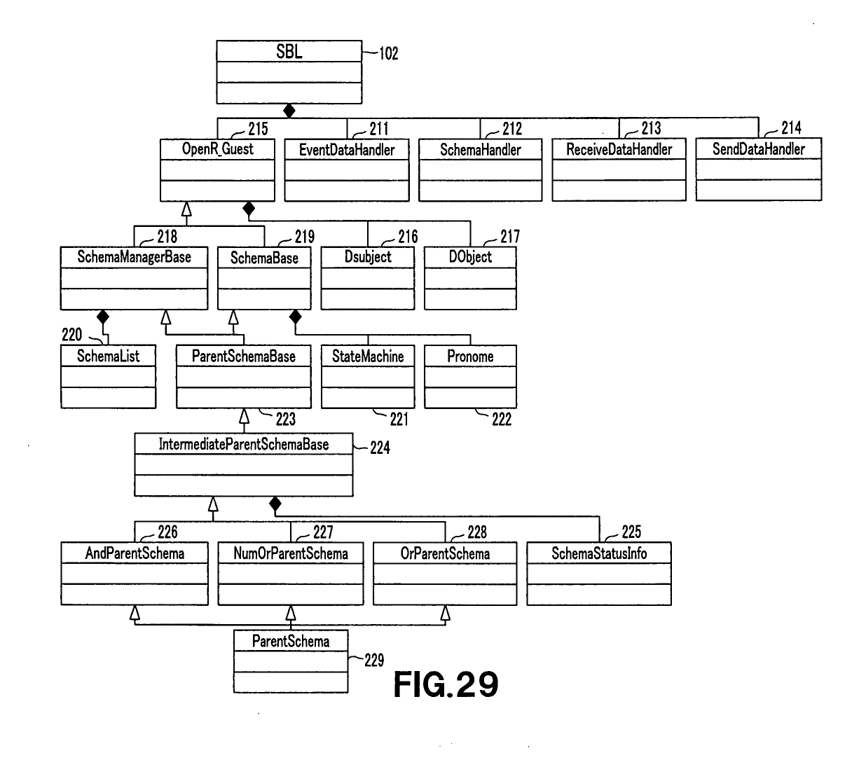

The schemas forming the situated behavior layer 102 and the reflexive situated behavior layer 103 may be stated as a ‘class object’ stated with e.g. the C++ language base. FIG. 29 schematically shows the schema class definition as used in the situated behavior layer 102. The blocks shown are each equivalent to one class object.

As shown, the situated behavior layer (SBL) 102 includes one or more schemas, an Event Data Handler (EDH) 211 for allocating an ID to each input/output event of the SBL 102, a Schema Handler (SH) 212 for supervising the schemas in the SBL 102, one of more Receive Data Handler (RDH) 213, receiving data from external objects (STM, LTM, resource managers, and objects of the recognition system), and one or more Send Data Handler (SD) 214, returning data to the external object.

Each Schema Handler 212 has stored therein the schemas making up the situated behavior layer (SBL) 102 and the reflexive situated behavior layer 103, and the information of e.g. the tree structure (configuration information of the SBL) as files. For example, the Schema Handler 212 reads in the configuration information file, such as at the time of booting the system, to construct (regenerate) the schema configuration of the situated behavior layer 102 to map te entity of each schema on the memory space.

Each schema includes an OpenR_Guest 215, that may be positioned as the base for the schema. The OpenR_Guest 215 includes one or more of class objects, namely a Dsubject 216 for the schema to transmit data to outside, and a DObject 217, for the schema to receive data from outside. For example, when the schema sends data to the external objects of the SBL 102 (such as STM, LTM, or objects of the recognition system), the Dsubject 216 writes transmission data in the Send Data Handler 214. The DObject 217 is able to read data, received from the external object of the SBL 102, from the Receive Data Handler 213.

A Schema Manager 218 and a Schema Base 219 are class objects which have inherited the Open_Guest 215. The class inheritance is the inheritance of the definition of the original class and, in this case, means that the Schema Manager 218 and the Schema Base 219 are also provided with class objects, such as Dsubject 216 or DObject 217, defined by the Open_Guest 215, hereinafter the same. For example, if plural schemas form a tree structure, as shown in FIG. 25, the Schema Manager Base 218 has a class object Schema List 220 for managing the child schemas, that is, has a pointer to the child schema, and hence is able to call the child schema function. The Schema Base 219 has a pointer to the parent schema and returns a return value of the function called by the parent schema.

The Schema Base 219 has two class objects, namely a State machine 221 and a Pronome 222. The State machine 221 supervises the state machine for the behavior of the schema (Action function). The parent schema is able to switch (cause state transition of) the state machine of the Action function of the child schema. In the Pronome 222, a target, the behavior (Action function) of which is executed or applied by the relevant schema, is substituted. The schema is occupied by the target, substituted into the Pronome 222, and is not released until the behavior (movement) comes to a close (by normal or abnormal termination). For carrying out the same behavior for a novel target, the schema of the same class definition is generated on the memory space, whereby the same schema may be executed independently from target to target, without work data of each schema conflicting with one another, thus assuring a reentrance property of the behavior, which will be explained subsequently.

A Parent Schema Base 223 is a class object inheriting the Schema Manager 218 and the Schema Base 219 by multiple inheritance and, in the schema tree structure, manages the parent schema and the child schema, that is, the parent-child relationship for the schema itself.

An Intermediate Schema Base 224 is a class object inheriting the Parent Schema Base 223, and implements interface conversion for respective classes. The Intermediate Schema Base 224 also has a Schema State Info 225. This Schema State Info 225 is a class object supervising the state machine of the schema itself. The parent schema is able to call the Action function of the child schema to switch the state of the state machine, and to call the Monitor function of the child schema to inquire into the activation level AL conforming to the normal state of the state machine. It should be noted however that the state machine of the schema is different from the state machine of the aforementioned Action function.

An AND Parent Schema 226, a Num Or Parent Schema 227 and an Or Parent Schema 228 is a class object inheriting the Intermediate Schema Base 224. The AND Parent Schema 226 has pointers to plural child schemas executed concurrently. The Or Parent Schema 228 includes a pointer to plural child schemas executed in an alternative fashion. The Num Or Parent Schema 227 includes a pointer to plural child schemas only a preset number of which are executed concurrently.

The Parent Schema 229 is a class object inheriting the AND Parent Schema 226, Num Or Parent Schema 227 and the Or Parent Schema 228 by multiple inheritance.

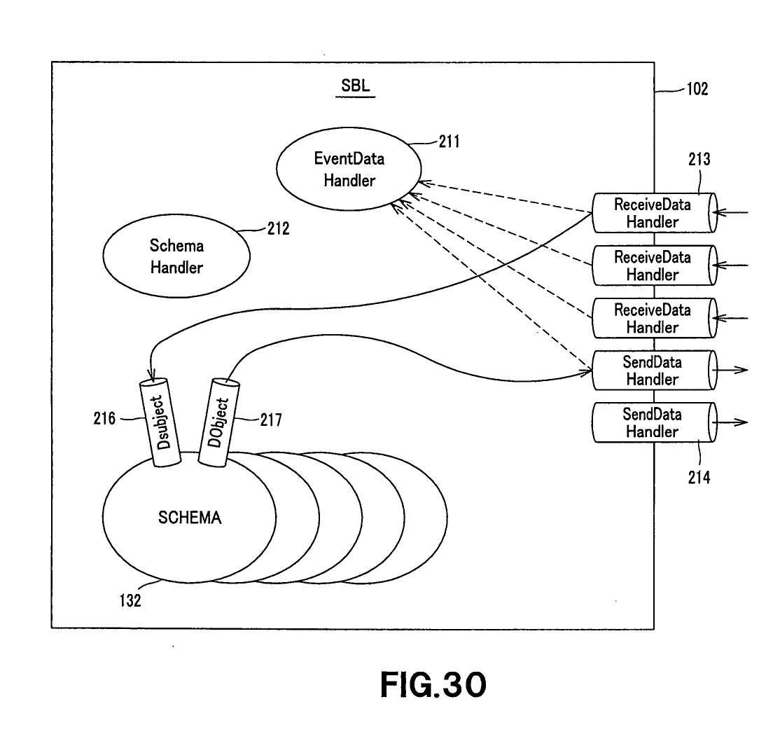

FIG. 30 schematically shows the functional class configuration in the situated behavior layer (SBL) 102. The situated behavior layer (SBL) 102 includes one of more Receive Data Handlers (RDHs) 213, receiving data from external objects, such as STM, LTM, resource manager or objects of the recognition system, and one or more Send Data Handlers (SDHs) 214 for sending data to the external objects.

The Event Data Handler (EDH) 211 is a class object for allocating IDs to the input/output events of the SBL 102, and receives notification from the RDH 213 and SDH 214.

The Schema Handler 212 is a class object for supervising the schema and has stored therein the configuration information for the schemas forming the SBL 102 as files. For example, on system booting, the Schema Handler 212 reads in this configuration information file to construct a schema configuration in the SBL 102.

Each schema is generated in accordance with the class definition shown in FIG. 29, and has its entity mapped on the memory space. Each schema has the Open_Guest 215 as the base class object and includes class objects, such as DSubject 216 or the DObject 217, for accessing outside data.

The functions and state machines, mainly owned by the schema, are shown below. The following functions are described with the Schema Base 219.
ActivationMonitor ( ): evaluation function for the Schema to become active when Ready.
Actions ( ): state machine for execution when Active.
Goal ( ): function for evaluating whether the schema has reached Goal when Active.
Fail ( ): function for evaluating whether the schema has failed when Active.
SleepActions ( ): state machine executed before Sleep.
SleepMonitor ( ): evaluation function to be resumed During Sleep
ResumeActions ( ): Sate machine to be resumed before Resume
DestroyMonitor ( ): Evaluation function for the schema to verify whether or not the schema has failed
MakePronome ( ): Function to determine the target of the entire tree
   (8-3) Function of Situated Behavior Layer

The situated behavior layer (SBL) 102 controls the behavior conforming to the current state of the robot apparatus 1, based on the storage contents of the short term memory 92, those of the long term memory 93 and on the inner state supervised by the self inner state management unit 91.

The situated behavior layer (SBL) 102 of the present embodiment is formed by the schema tree structure (see FIG. 25). Each schema is maintained in the independent state as it is aware of the information on the own child and parent. By this schema structure, the situated behavior layer 102 has main features of concurrent evaluation, concurrent execution, preemption and reentrant property. These features are now explained in detail.

(8-3-1) Concurrent Evaluation

The schema as the action describing module has the Monitor function of giving a judgment on the situation in keeping with the external stimuli and changes in the inner state. The Monitor function is mounted by the schema having the Monitor function as the class object Schema Base. The Monitor function is a function of calculating the activation level AL of the schema in question in dependence upon the external stimuli and the inner state.

In constructing the tree structure, shown in FIG. 25, the upper (parent) schema is able to call the Monitor function of the lower (child) schema, with the external stimuli 183 and the changes in the inner states 184 as arguments, and child schema has the activation level AL as a return value. The schema is also able to call the Monitor function of the child schema in order to calculate the self activation level AL. Since the activation level AL from each sub-tree is returned to the root schemas 201₁ to 203₁, an optimum schema, that is, an optimum behavior, may comprehensively be determined in dependence upon the external stimuli 183 and the changes in the inner states 184.

By virtue of this tree structure, the evaluation of each schema by the external stimuli 183 and the changes in the inner states 184 is concurrent, beginning from the lower end towards the upper end of the tree structure. That is, when the schema has a child schema, the Monitor function of the child selected is called, after which the self Monitor function is executed. The permission for execution, as the result of the evaluation, is then transmitted from an upper part towards a lower part of the tree structure. The evaluation and the execution are carried out as the competition of the resources used by the behavior is eliminated.

The situated behavior layer 102 in the present embodiment is able to evaluate the behavior in parallel fashion, by exploiting the schema tree structure, and hence is adaptable to such situation as the external stimuli 183 and the changes in the inner states 184. In addition, the entire tree is evaluated at the time of the evaluation and the tree is changed by the activation level AL calculated at this time, thus enabling dynamic prioritization of the schema, that is, the behavior ready for execution.

(8-3-2) Concurrent Execution

Since the activation level AL is returned from each sub-tree to the root schema, the optimum schema, that is, the optimum behavior, conforming to the external stimuli 183 and the changes in the inner states 184, can be verified comprehensively. For example, the schema with the highest activation level AL, may be selected, or two or more schemas, the activation level AL of which has exceeded a preset threshold value, may be selected and executed in parallel, on the presupposition that, for such parallel operation, there is no hardware competition among respective schemas.

The schema selected and allowed for execution is executed. That is, the schema actually observes the details of the external stimuli 183 and the changes in the inner states 184 to carry out the commands. The command is executed concurrently, that is, sequentially from the upper part towards the lower part of the tree structure. That is, if a schema has a child schema, the Actions function of the chills is executed.

The Action function includes a state machine describing the behavior (movements) proper to the schema itself. If the tree structure shown in FIG. 25 is formed, the parent schema is able to call the Action function to start or interrupt the execution of the child schema.

If, in the situated behavior layer (SBL) 102 in the present embodiment, exploiting the schema tree structure, there is no resource competition, it is possible to execute other schemas employing redundant resources simultaneously. However, if limitations are not imposed on the resources used up to the Goal, ill-assorted behavior may be produced. The situation-dependent behavior, determined by the situated behavior layer (SBL) 102, is applied to the motion controller through the process of arbitration of the hardware resources with the reflexive behavior by the reflexive situated behavior layer (reflexive SBL) 103 by the resource manager.

(8-3-3) Preemption

If a given schema has already started to be executed, but there is a behavior more crucial (higher in priority) than it, the schema started to be executed must be interrupted and must transfer the right for execution to the more crucial behavior. In addition, if once the more crucial behavior has come to a close (completed or discontinued), the former schema, once interrupted, must be re-stated and continue to be executed.

Such task execution conforming to the priority is analogous to the function termed preemption of the operating system (OS) in a computer. In the OS, tasks are executed in the order of the falling priority at a timing which takes the schedule into account.

Conversely, with the behavior control system 10 for the robot apparatus 1, in which the operations are astride plural objects, arbitration across plural objects is needed. For example, in the reflexive situated behavior layer 103, which is an object controlling the reflexive behavior, it is necessary to avoid an obstacle or to acquire balance without taking heed of the behavior evaluation of the situated behavior layer 102 as an object controlling the upper situation dependent behavior. This operation actually robs the object of the right for execution, however, this fact is intimated to the upper situation-dependent behavior layer (SBL), which SBL then carries out the corresponding processing to maintain the preemptive right.

It is also assumed that, by the evaluation of the activation level AL, which is based on the external stimuli 183 and the changes in the inner states 184, permission for execution is accorded to a certain schema. It is also assumed that, as a result of the evaluation of the activation level AL, which is based on the external stimuli 183 and the changes in the inner states 184, another schema has become higher in criticality. In such case, the schema being executed can be set to the sleep state and interrupted, using the Actions function of the schema being executed, in order to effect switching to the preemptive behavior.

The state of the Actions ( ) of the schema being executed is saved and the Actions ( ) of the different schema is executed. After end of the different schema, the Actions ( ) of the interrupted schema may again be executed.

Before interrupting the Actions ( ) of the schema being executed to transfer the right for execution to the different schema, the SleepActions ( ) is executed. For example, if the robot apparatus 1 has found a soccer ball during the dialog, it may say: ‘Just wait a moment’ to play soccer.

(8-3-4) Reentrant

Each schema of the situated behavior layer 102 is a sort of subroutine. In case the schema is called by plural parents, the schema needs to have a storage space in association with its parent in order to store its inner state.

This is analogous to the reentrant property of the OS and, in the present description, is termed a reentrant property of the schema. Referring to FIG. 30, the schema is formed by class objects, and the reentrant property is realized by generating an entity, that is, an instance, of the class object from target to target.

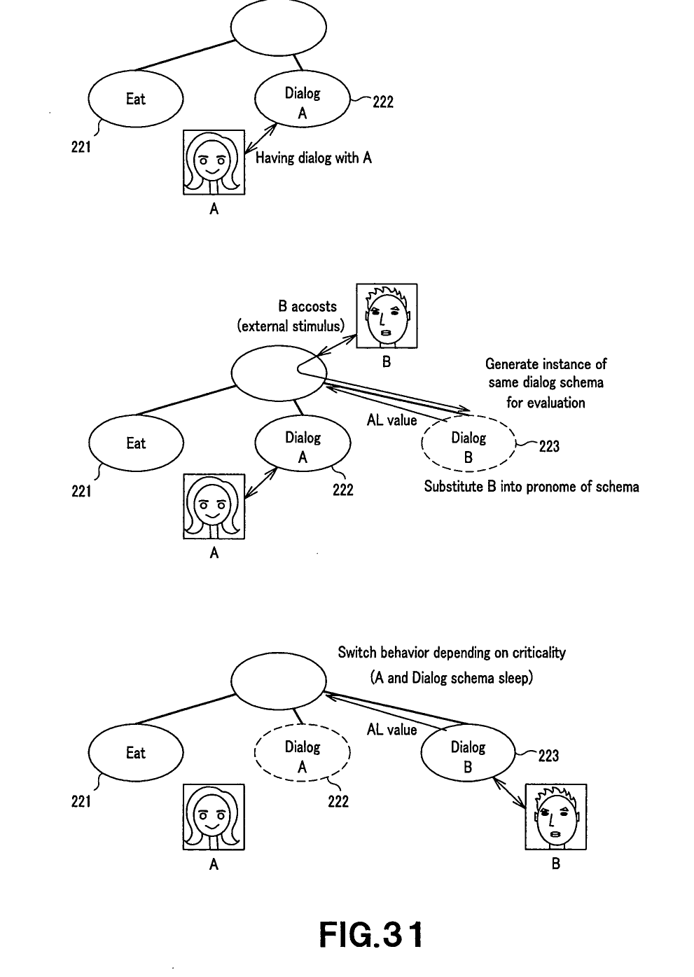

The reentrant property of the schema is explained more specifically by referring to FIG. 31. The Schema Handler 212 is a class object for supervising the schema and holds the configuration information of the schemas, forming the SBL 102, as a file. In booting the system, the Schema Handler 212 reads in this configuration file information to construct a schema configuration in the SBL 102. In the example shown in FIG. 31, it is assumed that the entities of the schemas, prescribing the behavior (movements), such as Eat 221 or Dialog 222, have been mapped on the memory space.

It is now assumed that, by the evaluation of the activation level AL, based on the external stimuli 183 and the changes in the inner states 184, a target (pronome) A is set for a schema dialog 222, and such schema dialog 222 is able to have the dialog with the person A.

It is also assumed that a person B has interrupted the dialog of the robot apparatus 1 with the person A and has evaluated the evaluation based on the external stimuli 183 and the changes in the inner states 184, as a result of which the schema 223 having the dialog with B has become higher in the priority.

In such case, the Schema Handler 212 maps, on the memory space, another Dialog entity (instance) which has inherited the class for having the dialog with the person B. Since the dialog with B is had, using another Dialog entity, independently of the previous Dialog entity, the contents of the dialog with A are not destroyed. Consequently, the Dialog with A may maintain data integrity. When the dialog with B has come to an end, the dialog with A may be re-started as from the point of previous interruption.

The schemas in the Ready list are evaluated in dependence upon the subject (external stimuli 183), that is, the Activation level AL is calculated and the rights of execution thereof are transferred. Subsequently, the instance of the schemas, moved into the Ready list, is generated, and evaluation for the other subjects is performed, whereby the same schema may be set to the active state or to the sleep state.

The control program, for realization of the above-described control system, is stored from the outset in a flash ROM 23, and is read out on power up of the robot apparatus 1. The robot apparatus 1 is able to act autonomously responsive to the own and surrounding state, responsive to commands and actions from the user.

1. A behavior control system in a robot apparatus, adapted for acting autonomously, comprising
activation level calculating means for calculating an activation level indicating the priority of execution of behaviors stated in a plurality of behavior describing models; and
behavior selection means for selecting at least one behavior based on said activation level;
said activation level calculating means including self activation level calculating means for calculating a self activation level, indicating the priority of execution of respective behaviors with the self as reference, counterpart activation level calculating means for calculating a counterpart activation level, indicating the priority of execution of the behaviors, with a counterpart, as subject of interaction, as reference, and activation level integrating means for calculating said activation level based on said self activation level and the counterpart activation level.

2. The behavior control system according to claim 1 comprising
external stimulus recognizing means for recognizing external stimuli to said robot apparatus from the sensor information;
self state management means for supervising the self state including at least plural sorts of self inner states;
counterpart state management means for supervising the counterpart state including at least plural sorts of counterpart inner states; and
parameter calculating means for calculating a parameter determining which of the self state and the counterpart state is to be made much of;
each of said behaviors being preset external stimuli and the preset self state associated with each other and preset external stimuli and the preset counterpart state associated with each other;
said self activation level calculating means calculating said self activation levels of respective behaviors based on preset external stimuli associated with said respective behaviors and on the preset self state;
said counterpart activation level calculating means calculating said counterpart activation levels of respective behaviors based on preset external stimuli associated with said respective behaviors and on the preset counterpart state;
said activation level integrating means integrating said self activation levels and said counterpart activation levels based on said parameter.

3. The behavior control system according to claim 2 wherein
said self state includes a plurality of sorts of self inner states and a plurality of sorts of self feelings and said counterpart state includes a plurality of sorts of counterpart inner states and a plurality of sorts of counterpart feelings.

4. The behavior control system according to claim 2 wherein
said parameter calculating means calculates said parameters based on said self state.

5. The behavior control system according to claim 2 wherein
said parameter calculating means calculates said parameters based on said counterpart state.

6. The behavior control system according to claim 2 wherein
said self activation level calculating means finds a self instinct value indicating the instinct for each behavior based on the current self state associated with each behavior and also finds an anticipated change in self satisfaction based on an anticipated change in the self state indicating a changed self state anticipated on the basis of said external stimuli; said self activation level calculating means calculating said self activation level associated with each behavior based on said self instinct value and on said anticipated change in the self state;
said counterpart activation level calculating means finds a counterpart instinct value indicating the instinct for each behavior based on the current counterpart state associated with each behavior and also finds an anticipated change in counterpart satisfaction based on an anticipated change in the counterpart state indicating a changed counterpart state anticipated on the basis of said external stimuli; said counterpart activation level calculating means calculating said counterpart activation level associated with each behavior based on said counterpart instinct value and on said anticipated change in the counterpart state.

7. The behavior control system according to claim 6 wherein
said self activation level calculating means finds the current self satisfaction from said current self state and calculates said self activation level for each behavior based on said self satisfaction, said anticipated changes in self satisfaction and on said self instinct value;
said counterpart activation level calculating means finds the current counterpart satisfaction from said current counterpart state and calculates said counterpart activation level for each behavior based on said counterpart satisfaction, said anticipated changes in counterpart satisfaction and on said counterpart instinct value.

8. The behavior control system according to claim 6 wherein
said self activation level calculating means refers to a database for calculating the self activation level, having stored therein said anticipated changes in the self state with respect to preset external stimuli associated with respective behaviors;
said counterpart activation level calculating means refers to a database for calculating the counterpart activation level, having stored therein said anticipated changes in the counterpart state with respect to preset external stimuli associated with respective behaviors.

9. A behavior control method in a robot apparatus, adapted for acting autonomously, comprising
an activation level calculating step for calculating an activation level indicating the priority of execution of behaviors stated in a plurality of behavior describing models; and
a behavior selection step for selecting at least one behavior based on said activation level;
said activation level calculating step including self activation level calculating step for calculating a self activation level, indicating the priority of execution of respective behaviors with the self as reference, counterpart activation level calculating step for calculating a counterpart activation level, indicating the priority of execution of the behaviors, with a counterpart, as subject of interaction, as reference, and activation level integrating step for calculating said activation level based on said self activation level and the counterpart activation level.

10. The behavior control method according to claim 9 comprising
an external stimulus recognizing step for recognizing external stimuli to said robot apparatus from the sensor information;
a self state management step for supervising the self state including at least plural sorts of self inner states;
a counterpart state management step for supervising the counterpart state including at least plural sorts of counterpart inner states; and
a parameter calculating step for calculating a parameter determining which of the self state and the counterpart state is to be made much of;
each of said behaviors being preset external stimuli and the preset self state associated with each other and preset external stimuli and the preset counterpart state associated with each other;
said self activation level calculating step calculating said self activation levels of respective behaviors based on preset external stimuli associated with said respective behaviors and on the preset self state;
said counterpart activation level calculating step calculating said counterpart activation levels of respective behaviors based on preset external stimuli associated with said respective behaviors and on the preset counterpart state;
said activation level integrating step integrating said self activation levels and said counterpart activation levels based on said parameter.

11. The behavior control method according to claim 10 wherein
said self state includes a plurality of sorts of self inner states and a plurality of sorts of self feelings and said counterpart state includes a plurality of sorts of counterpart inner states and a plurality of sorts of counterpart feelings.

12. The behavior control method according to claim 10 wherein
said parameter calculating step calculates said parameters based on said self state.

13. The behavior control method according to claim 10 wherein
said parameter calculating step calculates said parameters based on said counterpart state.

14. The behavior control method according to claim 10 wherein
said self activation level calculating step finds a self instinct value indicating the instinct for each behavior based on the current self state associated with each behavior and also finds an anticipated change in self satisfaction based on an anticipated change in the self state indicating a changed self state anticipated on the basis of said external stimuli; said self activation level calculating step calculating said self activation level associated with each behavior based on said self instinct value and on said anticipated change in the self state;
said counterpart activation level calculating step finds a counterpart instinct value indicating the instinct for each behavior based on the current counterpart state associated with each behavior and also finds an anticipated change in counterpart satisfaction based on an anticipated change in the counterpart state indicating a changed counterpart state anticipated on the basis of said external stimuli; said counterpart activation level calculating step calculating said counterpart activation level associated with each behavior based on said counterpart instinct value and on said anticipated change in the counterpart state.

15. The behavior control method according to claim 14 wherein
said self activation level calculating step finds the current self satisfaction from said current self state and calculates said self activation level for each behavior based on said self satisfaction, said anticipated changes in self satisfaction and on said self instinct value;
said counterpart activation level calculating step finds the current counterpart satisfaction from said current counterpart state and calculates said counterpart activation level for each behavior based on said counterpart satisfaction, said anticipated changes in counterpart satisfaction and on said counterpart instinct value.
